(19) United States
(12) Patent Application Publication
(10) Pub. No.: US 2025/0209328 A1
(43) Pub. Date: Jun. 26, 2025

(54) SYSTEM AND METHODS FOR ARTIFICIAL INTELLIGENCE INFERENCE

(71) Applicants: Weihua ZHUANG, Waterloo (CA); Kaige QU, Waterloo (CA); Wen WU, Waterloo (CA); Mushu LI, Waterloo (CA); Xuemin SHEN, Waterloo (CA); HUAWEI TECHNOLOGIES CANADA CO., LTD., Kanata (CA)

(72) Inventors: Weihua ZHUANG, Waterloo (CA); Kaige QU, Waterloo (CA); Wen WU, Waterloo (CA); Mushu LI, Kanata (CA); Xuemin SHEN, Waterloo (CA); Xu LI, Kanata (CA)

(73) Assignee: HUAWEI TECHNOLOGIES CANADA CO., LTD., Kanata (CA)

(21) Appl. No.: 19/077,680

(22) Filed: Mar. 12, 2025

Related U.S. Application Data
(63) Continuation of application No. PCT/CA2022/051493, filed on Oct. 11, 2022.

(51) Int. Cl. G06N 3/08; G06N 3/045

(52) U.S. Cl. CPC G06N 3/08; G06N 3/045

(57) ABSTRACT

System, methods and apparatuses for cumulative deep neural network (DNN) inference are provided. There is provided a data-driven cumulative DNN inference method which can aggregate multiple fast DNN inference results to obtain a cumulative DNN inference result and provide an improved cumulative confidence level. There is further provided a method for cumulative DNN inference, which can provide adaptive selection between a fast DNN inference, with low computing demand but low confidence level, and a full DNN inference, with high computing demand but high confidence level.

### CROSS-REFERENCE TO RELATED APPLICATIONS

This application is a continuation of International Application No. PCT/CA2022/051493, filed on Oct. 11, 2022, the disclosure of which is hereby incorporated by reference in its entirety.

### TECHNICAL FIELD

The present disclosure pertains to the field of artificial intelligence, and in particular to systems and methods for deep neural network (DNN) inference.

### BACKGROUND

Many artificial intelligence (AI) applications rely on deep neural network (DNN) models for classification. For AI inference, a pre-trained DNN model processes an input data sample, such as raw sensing data, and generates a classification result as output. For an AI classification task, usually one DNN inference is performed based on a single data sample. However, the confidence level requirement of the AI task may not be satisfied by a single DNN inference result, due to limited information provided by a single data sample and randomness in the DNN inference result.

For one AI task, there can be multiple available data samples; and for each data sample, there can be multiple different DNN inference results if the data sample is processed by multiple different DNN models. Different data samples usually capture different spatial and temporal features of the same object or event under detection. Different DNN models provide different inference results with randomness for the same data sample. Thus, the DNN inference results corresponding to different data samples and different DNN models provide different confidence levels. To improve the confidence level for the AI task, a straightforward approach is to select the DNN inference result with the maximum confidence level and ignore other DNN inference results with lower confidence levels. If the confidence level requirement is not satisfied, more data samples may be requested and used to obtain more DNN inference results. However, this approach may lead to high latency if the required confidence level is high, and this may violate delay requirements. Additionally, it can be inefficient to completely ignore DNN inference results with lower confidence levels.

Moreover, existing DNN models involve trade-offs between confidence level and computing demand. Typically, a big DNN model can generate DNN inference results with higher confidence levels on average at the cost of more computing demand. Thus, these models are usually deployed at powerful edge or cloud servers in the network. A small DNN model may provide lower confidence level but with more computing efficiency (or lower computing cost), and may therefore be deployed at the network edge, closer to data sources for the AI task. These trade-offs may be especially felt or needed when multiple AI tasks share resources such as transmission and computing resources in a network. Additionally, some elements on the network may be energy-limited such as Internet-of-things (IoT) devices and are not suitable for performing computation-intense tasks.

Therefore, it may be desired to improve the confidence level and delay performance of AI inference with resource and energy efficiency.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to systems and methods for artificial intelligence inference. For example artificial intelligence inference using both a fast DNN model and a full DNN model.

In accordance with an embodiment of the present disclosure, there is provided a method for cumulative deep neural network (DNN) inference. The method includes receiving, by a Type-D network element, fast DNN inference results for a first artificial intelligence (AI) task and receiving, by the Type-D network element, full DNN inference results for the first AI task. The method further includes obtaining, by the Type-D network element, a cumulative DNN inference result based on the fast DNN inference results and the full DNN inference results and obtaining, by the Type-D network element, a cumulative confidence level based on the fast DNN inference results and the full DNN inference results.

In some embodiments, receiving the full DNN inference results is responsive to an enhanced inference request. In some embodiments, the enhanced inference request is at least in part based on one or more of: dynamics of the cumulative confidence level, a caching status and a remaining time to a deadline associated with the first AI task. In some embodiments, the full DNN inference results are based on intermediate data, the intermediate data indicative of partial determination of the fast DNN inference results.

In accordance with an embodiment of the present disclosure, there is provided an apparatus for cumulative deep neural network (DNN) inference. The apparatus includes a processor, a network interface and a memory having stored thereon machine executable instructions. The instructions when executed by the processor configure the apparatus to receive fast DNN inference results for a first artificial intelligence (AI) task receive full DNN inference results for the first AI task. The instructions when executed by the processor further configure the apparatus to obtain a cumulative DNN inference result based on the fast DNN inference results and the full DNN inference results and obtain a cumulative confidence level based on the fast DNN inference results and the full DNN inference results.

In accordance with an embodiment of the present disclosure, there is provided a method for cumulative deep neural network (DNN) inference. The method includes transmitting, by a controller, one or more of a data request and an enhanced inference request, wherein the data request is for a first artificial intelligence (AI) task and wherein the enhanced inference request is for a full DNN inference result for the first AI task. The method further includes receiving, by the controller, a cumulative confidence level for a current DNN inference result and receiving, by the controller, task requirements for the first AI task.

In some embodiments, the method further includes determining, by the controller, acceptability of the cumulative DNN inference for the first AI task based at least in part on the task requirements and the cumulative confidence level. In some embodiments, the data request includes a request for one or more new data samples from a data source. In some embodiments, the data request includes a request of one or more new fast DNN inference results. In some embodiments, the enhanced inference request includes a request for one or more samples of intermediate data for determination of the full DNN inference result for the first AI task.

In some embodiments, the method further includes receiving, by the controller, the full DNN inference result and upon determination that the full DNN inference result is sufficient, transmitting, by the controller a notification to both a Type-B network element and a Type-D network element, this notification may be a sufficiency notification. In some embodiments, upon receipt of the notification, the Type-B network element will not perform or will cease performing a fast DNN inference (i.e. determining a fast DNN inference result). In some embodiments, upon receipt of the notification, the Type-D network element will not perform or will cease performing a cumulative DNN inference (i.e. determining a cumulative DNN inference result). In some embodiments, a notification indicating or instructing to cease the new fast DNN inference or the cumulative inference is respectively sent to the Type-B network element and the Type-D network element, and the Type-B network element and the Type-D network element according to the notification will respectively not perform or cease performing the fast DNN inference or the cumulative inference. In some embodiments, the task requirements include information indicative of one or more of a deadline and a confidence level. In some embodiments, the deadline includes a delay threshold and the confidence level includes a confidence level threshold. In some embodiments, the first AI task is completed upon the cumulative confidence level reaching the confidence level threshold. In some embodiments, the first AI task is completed with a satisfactory quality of service (QoS) upon the first AI task being completed by at least the delay threshold. In some embodiments, a delay violation occurs when the first AI task is completed after the delay threshold.

In accordance with an embodiment of the present disclosure, there is provided an apparatus for cumulative deep neural network (DNN) inference. The apparatus includes a processor, a network interface and a memory having stored thereon machine executable instructions. The instructions when executed by the processor configure the apparatus to transmit a data request for a first artificial intelligence (AI) task and transmit an enhanced inference request for a full DNN inference result for the first AI task. The instructions when executed by the processor further configure the apparatus to receive a cumulative confidence level for a current DNN inference result, receive task requirements for the first AI task and determine acceptability of the cumulative DNN inference for the first AI task based at least in part on the task requirements and the cumulative confidence level.

In accordance with an embodiment of the present disclosure, there is provided a method for cumulative deep neural network (DNN) inference. The method includes receiving, by a Type-B network element, a data sample for a first artificial intelligence (AI) task and upon determination of a fast DNN inference based on the new data sample, transmitting, by the Type B network element to a Type-D network element, the fast DNN inference result for the first AI task. The method further includes receiving, by the Type-B network element, an enhanced inference request, caching, by the Type-B network element, one or more samples of intermediate data, based on the enhance inference request, the intermediate data indicative of partial determination of the fast DNN inference results and transmitting, by the Type-B network element, the one or more samples of intermediate data.

In some embodiments, the Type-B network element transmits the one or more samples of intermediate data to a Type-C network element. In some embodiments, the method further includes receiving, by the Type-B network element, a data request, the data request indicative of one or more of: a request for one or more samples of intermediate data and a request for a new data sample. In some embodiments, the method further includes determining, by Type-B network element, a new fast DNN inference at least in part based on the new data sample and transmitting, by the Type B network element to the Type-D network element, the new fast DNN inference result for the first AI task. In some embodiments, upon receipt of the one or more samples of intermediate data, the Type-C network element is configured to generate a full DNN inference. In some embodiments, the Type-C network element is configured to transmit the full DNN inference to a Type-D network element, the Type-D network element configured to generate a cumulative DNN inference result at least in part based on the full DNN inference.

In accordance with an embodiment of the present disclosure, there is provided an apparatus for cumulative deep neural network (DNN) inference. The apparatus includes a processor, a network interface and a memory having stored thereon machine executable instructions. The instructions when executed by the processor configure the apparatus to receive a data sample for a first artificial intelligence (AI) task and upon determination of a fast DNN inference based on the new data sample, transmit the fast DNN inference result for the first AI task. The instructions when executed by the processor further configure the apparatus to receive network element, an enhanced inference request, cache one or more samples of intermediate data, based on the enhance inference request and transmit the one or more samples of intermediate data.

In accordance with an embodiment of the present disclosure, there is provided a system for cumulative deep neural network (DNN) inference. The system includes a controller, a Type-B network element and a Type-D network element, each of the controller, the Type-B network element and the Type-D network element having one or more associated processors and one or more associated memories stored machine readable instructions. Upon execution of the machine readable instructions by at least one of the one or more associated processors, the Type-B network element is configured to receive a new data sample for a first artificial intelligence (AI) task and upon determination of a fast DNN inference based on the new data sample, transmit to the Type-D network element, the fast DNN inference result for the first AI task. Upon execution of the machine readable instructions by at least one of the one or more associated processors, the Type-D network element is configured to receive the fast DNN inference results for a first artificial intelligence (AI) task, obtain a cumulative DNN inference result based on the fast DNN inference results and obtain a cumulative confidence level based on the fast DNN inference results. Upon execution of the machine readable instructions by at least one of the one or more associated processors, the controller is configured to transmit one or more of a data request and an enhanced inference request, wherein the data request is for a first artificial intelligence (AI) task and wherein the enhanced inference request is for a full DNN inference result for the first AI task and receive the cumulative confidence level for a current DNN inference result. Upon execution of the machine readable instructions by at least one of the one or more associated processors, the controller is further configured to receive task requirements for the first AI task and determine acceptability of the current cumulative DNN inference for the first AI task based at least in part on the task requirements and the cumulative confidence level.

In some embodiments, upon execution of the machine readable instructions by at least one of the one or more associated processors, the Type-B network element is further configured to receive the enhanced inference request, cache one or more samples of intermediate data, based on the enhance inference request, the intermediate data indicative of partial determination of the fast DNN inference results and transmit the one or more samples of intermediate data.

In some embodiments, the system further includes a Type-C network element having one or more associated processors and one or more associated memories stored machine readable instructions. Upon execution of the machine readable instructions by at least one of the one or more associated processors, the Type-C network element is configured to receive the one or more samples of intermediate data and based on the one or more samples of intermediate data, generate a full DNN inference and transmit the full DNN inference to the Type-D network element.

In some embodiments, upon execution of the machine readable instructions by at least one of the one or more associated processors, the Type-D network element is further configured to receive the full DNN inference results for the first AI task, obtain a cumulative DNN inference result based on the fast DNN inference results and the full DNN inference results and obtain a cumulative confidence level based on the fast DNN inference results and the full DNN inference results.

According to embodiments, there is provided a cumulative DNN inference scheme, which cumulatively combines multiple DNN inference results from different DNN models and generates a cumulative DNN inference result with improved confidence level. This can be provided by exploiting the information diversity of different DNN inference results, based on a non-parametric joint probability density function profiling of DNN inference results of different DNN models with a labelled training dataset.

According to embodiments, there is provided an adaptive control scheme for a cumulative DNN inference framework where a computation-efficient AI model deployment strategy with layer sharing between fast and full DNN models is employed for multiple AI tasks. With the adaptive selection between fast and full DNN inference for each AI task by a reinforcement learning (RL) agent with the consideration of dynamics in cumulative confidence level, caching status, and remaining time to a deadline associated with different AI tasks, the resource and energy efficiency may be maximized, and the total delay violation penalty may be minimized for the satisfaction of confidence level requirements of all AI tasks.

According to embodiments, there is provided an extra experience replay memory and a corresponding enabling mechanism in a deep Q leaning algorithm. The extra experience replay memory can store transitions in zero-penalty episodes and can improve the convergence for an RL problem with a special episode-level penalty which depends on all actions in the whole episode.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates fast and full deep neural network models with layer sharing before a common cut layer, according to one aspect of the present disclosure.

FIG. 2 illustrates a diagram of a device-edge co-inference framework for cumulative DNN inference with multiple devices, according to one aspect of the present disclosure.

FIG. 3 illustrates an adaptive control framework for cumulative DNN inference of multiple AI tasks in general application scenarios, according to an aspect of the present disclosure.

FIG. 4 illustrates a single-sensor application scenario with a single access point, according to an aspect of the present disclosure.

FIG. 5 illustrates a multi-sensor application scenario with multiple sensors under the coverage of a single access point, according to an aspect of the present disclosure.

FIG. 6 illustrates a multi-sensor application scenario with multiple data sources and multiple access points, according to an aspect of the present disclosure.

FIG. 7 illustrates a flow chart of a cumulative DNN inference scheme for J fast or full DNN inference results, according to one aspect of the present disclosure.

FIG. 8 illustrates a modified deep Q learning scheme, according to an aspect of the present disclosure.

FIG. 9 illustrates a flow chart of a Deep Q learning scheme with extra experience replay, according to an aspect of the present disclosure

FIG. 10 illustrates a simulated fast and full DNN model architecture in accordance with embodiments of the present disclosure.

FIG. 11A illustrates a relationship between a cumulative confidence level and a number of data samples for a full DNN inference, according to the simulation according to FIG. 10.

FIG. 11B illustrates a relationship between a cumulative confidence level and a number of data samples for a fast DNN inference, according to the simulation according to FIG. 10.

FIG. 12 illustrates a relationship between accuracy and the number of data samples for both a fast and full DNN inference, according to the simulation according to FIG. 10.

FIG. 13 illustrates a training loss verses learning step for different confidence level requirements for ω₁=0.9, according to an example in accordance with embodiments of the present disclosure.

FIG. 14 illustrates an episodic total reward versus training episode for different confidence level requirements for ω₁=0.9, according to an example in accordance with embodiments of the present disclosure.

FIG. 15A illustrates a cost comparison during training with different confidence level requirements for ω₁=0.9 for average resource consumption, according to an example in accordance with embodiments of the present disclosure.

FIG. 15B illustrates a cost comparison during training with different confidence level requirements for ω₁=0.9 for total local energy, according to an example in accordance with embodiments of the present disclosure.

FIGS. 16A, 16B and 16C illustrate an increase of cumulative confidence levels over time at different confidence level requirements (η_{T}), according to an example in accordance with embodiments of the present disclosure.

FIG. 17 illustrates a comparison of episodic total reward versus training episode with and without extra experience replay memory, according to an example in accordance with embodiments of the present disclosure.

FIG. 18 illustrates a comparison of episodic total penalty versus training episode with and without extra experience replay memory, according to an example in accordance with embodiments of the present disclosure.

FIG. 19 is a schematic diagram of an electronic device that may perform any or all of the operations of the above methods and features explicitly or implicitly described herein, according to different embodiments of the present disclosure.

It will be noted that throughout the appended drawings, like features are identified by like reference numerals.

### DETAILED DESCRIPTION

A deep neural network (DNN) may be used to classify an object as one of y labels or classes, such as values from 1 to K. The DNN can estimate the conditional probability based on a data sample x that the object is of class y, or P(y|x). This DNN inference may result in a predicted class probability vector \hat{z}={\hat{z}ₖ, k=1, . . . , K} with \hat{z}ₖ=P(y=k|x), with a confidence level of

$$η ( \hat{z} ) = 1 - ( - {\sum }_{k = 1}^{K} \frac{{\hat{z}}_{k} log {\hat{z}}_{k}}{log K} ) ,$$

or 1 minus normalized entropy. This approach may be used to perform one DNN inference based on a single data sample. However, a given task may have a confidence level requirement, which may not be satisfied by a single DNN inference result, due to an accuracy limit of DNN models and/or incomplete information provided by a single DNN sample. Moreover, it can also be difficult to balance between accuracy and computing overhead, e.g. meeting higher accuracy requirements while limiting computing demand/overhead.

An adaptive and cumulative DNN inference scheme can be used to generate more accurate classifications, including aggregating multiple DNN inference results to form a combined DNN inference with high (e.g., improved) confidence level. The scheme can place fast DNN functionality at network elements or network entities (“Type B network elements (or Type B network entities)”) which are at or closer to data sources (“Type A network elements (or Type A network entities)”), while maintaining more sophisticated enhanced DNN inference functionality at network elements or network entities (“Type C network elements (or Type C network entities”) which may be further from the data sources.

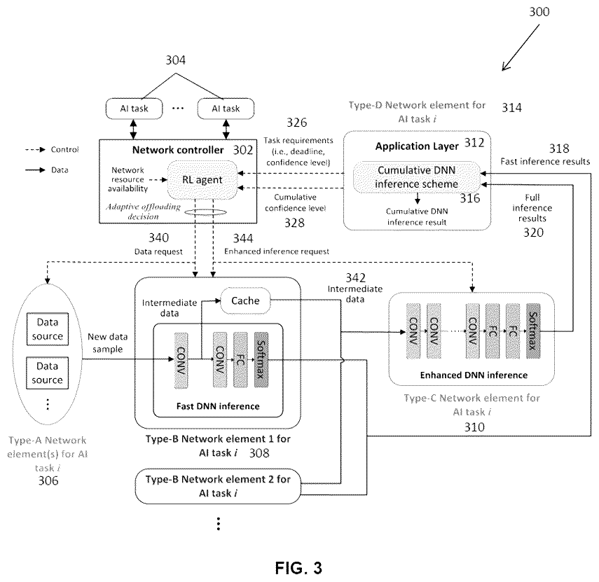

It will be understood that Type-A network element(s), Type-B network element(s), Type-C network element(s) and Type-D network element(s) as described in more detail elsewhere herein, for example as illustrated in FIG. 3 and further discussed herein in association therewith, are logical network elements, or in other words, logical network functions. These network elements can be deployed at different network locations (e.g. a device (such as a UE), a cloud environment in radio access network (RAN), a cloud environment in the core network, or a cloud environment in a data network. In addition, one or more of the Type-B network element(s), Type-C network element(s), Type-D network element(s) can be integrated into (or implemented by) a same network entity.

A network controller may run the scheme, sending data requests and enhanced inference requests given both network-level information (such as network resource availability) and application-level information (such as current cumulative confidence level, task confidence level requirement, and task completion time requirement). The network controller may use a reinforcement learning (RL) agent for decision making. A data request may be used to request one or more new data samples from one or more data sources and execute fast DNN inference at one or more Type B network elements which are associated with the requested data sample(s) to obtain one or more fast inference results. An enhanced inference request may trigger the execution of an enhanced DNN inference (or a full DNN inference) at a Type C network element, and the enhanced DNN inference may be executed based on cached intermediate data offloaded from a Type B network element, to obtain a new full inference result. A stochastic cumulative DNN inference scheme, e.g. running at the application layer, may provide the cumulative confidence level based on all fast and full inference results corresponding to the same AI task. According to embodiments, a full DNN inference can be considered to involve both local computing to generate intermediate data and edge computing for enhanced DNN inference based on this intermediate data.

Thus, one aspect of this disclosure describes a data-driven stochastic cumulative DNN inference scheme which statistically aggregates multiple DNN inference results to obtain a cumulative DNN inference result and provides an improved cumulative confidence level. Such a system may also include a control scheme for cumulative DNN inference, which can provide adaptive selection between a fast DNN inference, with low computing demand but low confidence level, and a full DNN inference, with high computing demand but high confidence level. This selection may be made to satisfy the confidence level requirements of multiple AI tasks and the selection may seek to maximize energy and resource efficiency and minimum delay violation.

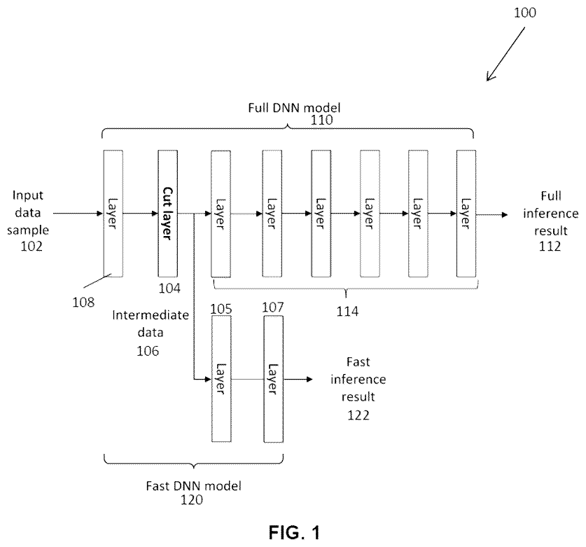

FIG. 1 illustrates 100 a fast DNN model 120 and a full DNN model 110 with layer sharing (i.e. shared layer 108) before and at a common cut layer 104, according to one aspect of the present disclosure. The fast DNN model 120 includes layers 108, 104, 105 and 107. The full DNN model 110 includes layers 108, 104 and 114.

The fast DNN model 120 may be deployed at multiple network entities in a network, such as at network entities which are positioned close to data sources that generate input data samples 102. The execution of the fast DNN model 120 may be referred to as a fast DNN inference, which generates a fast inference result 122 for each input data sample 102. For each execution of the fast DNN model 120, the output at the cut layer 104 can be referred to as intermediate data 106.

The full DNN model 110 may be partitioned into two parts by the cut layer 104. The layer(s) 108 before and at the cut layer 104 may be shared between the full DNN model 110 and the fast DNN model 120, while the layers 114 after the cut layer 104 may be used only by the full DNN model 110. As such, for the full DNN model 110 the layers 114 thereof after the cut layer 104 may be deployed at a network entity which is relatively further from data sources, such as at an access point (AP). For clarity on deployment in association with the full DNN model, the full DNN model includes two parts, namely the part before the cut layer and the part after the cut layer. Generally, either part can be deployed far from the data sources. However, the part after the cut layer, namely layers 114, can be further from the data sources when compared to the part, namely layer(s) 108 before the cut layer. The full DNN model 110 may be configured to receive data from multiple data sources. The intermediate data 106 at the cut layer 104 can be further processed by the layers 114 after the cut layer 104 at the AP to generate a full inference result 112, which can be referred to as enhanced DNN inference. It will be readily understood that the intermediate data 106 can be a combination of one or more pieces or samples of intermediate data, and as such, the further processing at layers 114 can be performed on one or more samples of the intermediate data 106.

As illustrated, some of the computation is shared between the full DNN model 110 and the fast DNN model 120. Specifically, both models 110, 120 share the layer(s) 108 before the cut layer 104 and both further include the cut layer 104. By sharing some computation between the fast DNN model 120 and the full DNN model 110, the computing demand for generating one fast DNN inference result and one full DNN inference result may be reduced when compared with an AI model deployment strategy without layer sharing between the fast and full DNN models 110, 120.

Generally, the full DNN model 110, in particular layers 114, may be implemented on a network entity in a network, such as an AP, which can be referred to as a Type C network element or Type C network entity. The fast DNN model 120 may be implemented on another network entity in the network, such as an Internet of Things (IoT) device like a smart camera, which can be referred to as a Type B network element or Type B network entity. Each of these network entities can be configured to run an AI task, such as a DNN-based classification task for AI inference, with multiple data samples generated by one or more data sources such as a data source within an IoT device. For example, a smart camera is an IoT device which may generate consecutive video frames and these video frames may be used for the classification of a moving object.

The IoT device or other network entity, which can be defined as a Type B network element, may support some local processing, sufficient to run the fast DNN model 120, but the operation thereof may be limited by one or more of computing resources- and energy. Meanwhile, a network entity, e.g., an AP, may have a higher computing capability, which can be defined as a Type C network element, e.g. due to an edge server or cloud server integrated within or co-located with the network entity. The network entity may serve some network entities (e.g. user devices) which initiate AI tasks, and the computing resources of the network entity may be shared by the multiple network entities. Each of these devices may be allocated with a virtual CPU at the network entity for AI processing. In some embodiments, the network entity and the other devices being served by the network entity, for example Type B network elements, may be connected to one another via a wireless network, such as an OFDMA network.

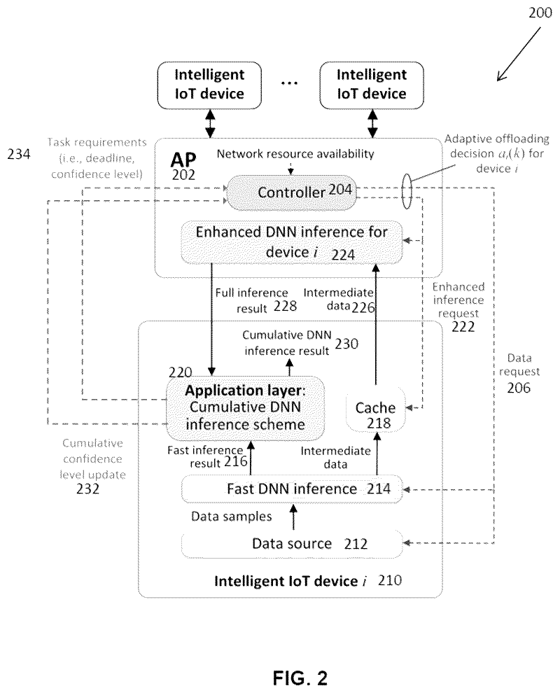

FIG. 2 illustrates 200 a diagram of a device (e.g. Type A and Type B network entities)-edge (e.g. Type C network entity) co-inference framework for cumulative DNN inference with multiple network entities that are being served by the Type-C network entity, according to one aspect of the present disclosure. This framework may be used to perform the fast and full DNN inferences described in illustration 100.

The framework includes a network entity which in this example has been illustrated as an AP 202 which has a controller 204 (or network controller) and a module for enhanced DNN inferences, such as enhanced DNN inferences for IoT device i 224. The AP 202 may be serving, and connected to one or more IoT devices, including IoT device i 210. It is to be readily understood that in this figure AP is being used as an example and should not be considered to be limiting. The network entity, which in this example has been illustrated as an AP, is configured to perform the particular actions discussed elsewhere herein in association with this example. Moreover, a network entity can be AP, a UE, a based station, a IoT device or other suitable network entity as would be readily understood.

The controller 204 at the AP 202 may be configured to make adaptive offloading decisions among multiple devices across consecutive time slots based on both network-level information (such as network resource availability including the transmission resource availability and the computing resource availability at the AP 202) and application-level information, until the confidence level requirements for the AI tasks of all the devices are satisfied. For example, each AI task may have certain requirements for completion time and for confidence level needed, and the controller 204 may be configured to choose whether to use enhanced DNN inference for device i 224 or a fast DNN inference 214, based on these trade-offs between timeliness of completion, confidence level, and computing resource availability.

For example, let aᵢ(k) denote a nonnegative integer offloading decision for network entity i 210 at time slot k, which represents the number of pieces or portions of the intermediate data 226 to offload from network entity i 210 to the AP 202 during time slot k. It will be readily understood that the intermediate data 226 can be a combination of one or more pieces or samples of intermediate data, and as such, the offloading of the intermediate data can be envisioned as offloading one or more of the pieces or samples of the intermediate data.

If the offloading decision for network entity i 210 is not to offload at time slot k, i.e., aᵢ(k)=0, no offloading takes place at network entity i 210, but a data request 206 for the network entity i 210 is initiated by the controller 204 at time slot k. The controller 204 notifies both the data source 212 and the fast DNN inference 214 module for network entity i 210 of the data request 206. Then, the data source 212 of network entity i 210 can provide a new data sample to the fast DNN inference 214 module for the network entity.

With a new data sample for network entity i 210 at time slot k, fast DNN inference 214 is executed by running the fast DNN model at network entity i 210 to obtain a new fast inference result 216 during time slot k. The new fast inference result 216 is then passed to an application-layer cumulative DNN inference module 220 for network entity i 210, which runs a stochastic DNN inference scheme.

A cache 218 can be placed at each network entity, including network entity i 210. For each execution of fast DNN inference 214 with a new data sample at network entity i 210, intermediate data 226, i.e., the layer output at the shared cut layer between the fast and full DNN models, is temporarily stored in the cache 218 of network entity i 210, and the caching state (i.e., cached intermediate data 226) at network entity i 210 is increased by one. Let qᵢ(k) denote the caching state of network entity i 210 at the beginning of time slot k, which is initialized as qᵢ(1)=0 at the beginning of the first time slot for the AI task of network entity i 210. Then, if aᵢ(k)=0, we have qᵢ(k+1)=qᵢ(k)+1.

If the offloading decision for network entity i 210 is to offload at time slot k, i.e., aᵢ(k)>0, an enhanced inference request 222 for the network entity is initiated by the controller 204 at time slot k. The controller 204 notifies both the enhanced DNN inference module 224 for network entity i 210 at the AP 202 and the cache 218 module at network entity i 210 of the enhanced inference request 222. Then, aᵢ(k) intermediate data 226 is offloaded from the cache 218 of network entity i 210 to the AP 202, and processed with enhanced DNN inference 224 at the AP 202. Accordingly, the caching state at network entity i 210 is decreased by aᵢ(k) at the beginning of time slot k+1, i.e., qᵢ(k+1)=qᵢ(k)−aᵢ(k).

If intermediate data 226 is offloaded to the AP 202 from network entity i 210 during time slot k, i.e., aᵢ(k)>0, the AP 202 executes enhanced DNN inference 224 for each portion of the offloaded intermediate data 226 and generates a corresponding number of full inference results 228 during time slot k. The new full inference results 228 can then be passed to the application-layer cumulative DNN inference module 220 for the network entity i 210.

For network entity i 210, the application-layer cumulative DNN inference module 220 receives one new fast inference result 216 during time slot k if aᵢ(k)=0, or aᵢ(k) full inference result(s) 228 during time slot k if aᵢ(k)>0. The application-layer cumulative DNN inference module 220 aggregates the new inference results with the old ones received in previous time slots and updates a cumulative DNN inference result 230 for the AI task of network entity i 210, based on a proposed stochastic cumulative DNN inference scheme. The confidence level of the cumulative DNN inference result is referred to as the cumulative confidence level. Let ηᵢ(k) denote the cumulative confidence level for the AI task of network entity i 210 at the beginning of time slot k, which is initialized as ηᵢ(1)=0 at the beginning of the first time slot for the AI task. Based on the updated cumulative DNN inference result for the AI task of network entity i 210, a corresponding updated cumulative confidence level 232 can be calculated. At the end of time slot k, the controller 204 is informed of the updated cumulative confidence levels 232 for the AI tasks of all network entity, e.g., ηᵢ(k+1) for the AI task of network entity i 210. The application layer 220 of the AI task of network entity i 210 also provides the task requirements 234 including confidence level requirement and the delay requirement to the controller 204 for initialization before the execution of AI tasks.

According to embodiments, the confidence level of a DNN inference result (predicted class probability vector) is further defined elsewhere herein, can has a value range between 0 and 1. A confidence level requirement or confidence threshold, η_{T}, can be a value between 0 and 1, which defines a threshold for the confidence level of the result. This can be the associated confidence with either a DNN inference result based on a single data sample or a cumulative DNN inference result based on multiple data samples for a classification task. It will be understood that these data samples can be considered to be samples of the intermediate data. If the value associated with the confidence threshold is larger, the confidence level threshold requirement is more stringent.

According to embodiments, with the cumulative DNN inference scheme, the confidence level of the cumulative DNN inference result, which may also be referred to as a cumulative confidence level, for the classification task gradually increases, with fluctuations, by combining more DNN inference results over time. The increase in the cumulative confidence level can continue to increase until it reaches the confidence level threshold, namely a confidence level requirement, at which point the classification task is completed.

According to embodiments, the delay requirement is a value, which defines a delay threshold for the classification task. If the confidence level threshold is satisfied before or at a delay threshold, the classification task is considered to be successful with a satisfactory quality of service (QoS). Otherwise, there is a delay violation penalty applied to the corresponding network entity which initiated the classification task. An example of a delay requirement can be 100 ms, is or other time period which may be determined based on the application layer's requirement.

Aspects of this disclosure can improve the confidence level and delay performance of AI inference with energy and resource efficiency, using the following design elements. Each design element is described in more detail below.

Stochastic cumulative DNN inference scheme: For the AI task of each network entity, multiple fast and full inference results based on different data samples can be used by the application layer. A stochastic cumulative DNN inference scheme can aggregate multiple DNN inference results, calculate a cumulative DNN inference result, and update a cumulative confidence level. By aggregating more DNN inference results, the cumulative confidence level may be improved.

An adaptive control scheme for cumulative DNN inference will be further described. The controller 204 can adaptively decide when to request new data samples for fast DNN inference 214 at the network entity, and how to offload the intermediate data 226 from caches at the network entity to the AP 202 for enhanced DNN inference. These decisions may consider dynamics in current cumulative confidence level, caching status, and remaining time to deadline for the AI task of each network entity over time. Specifically, the controller 204 can periodically make offloading decisions for the AI tasks of multiple network entity, which can be interpreted as either data requests or enhanced inference requests, depending on the value of offloading decisions.

If the offloading decision for an AI task at a time slot is not to offload, a data request can be sent from the network controller to data sources (Type-A network elements or network entities) of the AI task. The network controller can also notify a Type-B network element of the data request. Then, the data sources send a new data sample to the fast DNN inference module at the notified Type-B network element.

If the offloading decision for an AI task at a time slot is to offload, an enhanced inference request may be sent from the network controller to both a Type-B network element and a Type-C network element for the AI task, to request one or more pieces or samples of the intermediate data stored in the cache of the Type-B network element to be offloaded to the Type-C network element.

A deep Q learning algorithm with extra experience replay will be further described. A modified deep Q learning algorithm with extra experience replay may be used to determine when to adaptively offload AI tasks. Besides an ordinary experience replay which stores each transition over time, the extra experience replay may be configured to store transitions in episodes with no delay violation penalty for all AI tasks of different devices, which can help the learning agent to learn more from these good and rare transitions and converges to desired solution with minimum delay violation penalty.

In some embodiments, the controller 204 is configured to determine whether a cumulative DNN inference is to be performed. For example, if the controller 204 determines that a full DNN inference is sufficient (i.e. meets the confidence level requirement of the AI task), for example based on task requirement and/or confidence level requirement, the controller 204 may inform, by for example transmitting a notification, the network element i 210 and the application-layer cumulative DNN inference module 220 of the sufficiency of the full DNN inference. For example, this notification may in some instances be a sufficiency notification. Upon receipt of the notification, the network element i 210 will not perform or will cease performing a fast DNN inference (i.e. determine a fast DNN inference result). In addition, upon receipt of the notification, the application-layer cumulative DNN inference module 220 will not perform or will cease performing a cumulative inference. It will be readily understood that the notification sent to the network element i 210 may be the same as or similar to, or may be different from the notification sent to the application-layer cumulative DNN inference module 220 in configuration and/or information therein, and that each of these notifications will have information or instructions which is suitable for and understandable by the respective network element to which it is transmitted and received thereby. In some embodiments, a notification indicating or instructing to cease the fast DNN inference or the cumulative inference is respectively sent to the network element i 210 and the application-layer cumulative DNN inference module 220, and the network element i 210 and the application-layer cumulative DNN inference module 220 according to the notification will respectively not perform or cease performing the fast DNN inference or the cumulative inference. It will be readily understood that the notification sent to the network element i 210 may be the same as or similar to, or may be different from the notification sent to the application-layer cumulative DNN inference module 220 in configuration and/or information therein, and that each of these notifications will have information or instructions which is suitable for and understandable by the respective network element to which it is transmitted and received thereby.

FIG. 3 illustrates an adaptive control framework 300 for cumulative DNN inference of multiple AI tasks in general application scenarios, according to an aspect of the present disclosure. According to embodiments, FIG. 3 may be considered to be a generalized extension of FIG. 2. The framework 300 includes a more generalized set of network entities than those in illustration 200, separating Type A network elements or Type A network entities (e,g, data sources) 306, Type B network elements or Type B network entities 308 (e.g. those network entities with fast DNN inference), Type C network elements or Type C network entities 310 (e.g. those network entities with enhanced DNN inference), a Type D network element or Type D network entity 314, and a network controller 302. Each of these elements (or entities) could be separate network entities in a network, or could be combined together as a combination thereof, wherein some of these possible combinations are described in more depth elsewhere herein.

A general scenario can include one network controller 302 and multiple AI tasks 304. For each AI task 304, there may be one or more data sources which provide data samples for AI inference, such as the Type A network elements for AI task i 306. Each AI task 304 may also include one or more Type B network elements 308 close to data sources but with limited computing resources. The Type B network elements 308 may provide fast DNN inference functionality and caching functionality, as described above.

The network can also include a Type-C network element 310 farther from the data sources but with abundant computing resources, which can be shared among multiple AI tasks, such as AI tasks 304, and can provide enhanced DNN inference functionality. Moreover, the application layer 312 for an AI task can be placed at another network element other than the Type-B 308 or Type-C 310 network elements, which is referred to as Type-D network element 314. The Type-D network element 314 includes a cumulative DNN inference module 316, which is the same as the cumulative DNN inference module 216 and supports cumulative DNN inference for an AI task, and the fast inference results 318 (same as the fast inference results 216) or full inference results 320 (same as the full inference results 228) for the AI task should be transmitted to the corresponding Type-D network element 314. In some embodiments, the Type-D network element 314 is split into two network entities, e.g. a control plane entity and a data plane entity. The data plane entity includes the cumulative DNN inference module 316 and receives the fast inference results 318 and the full inference results 320; the control plane entity provides the task requirements 326 and the cumulative confidence level 328 to the network controller 302. This may be considered to be similar to the task requirements 234 and the cumulative confidence level update 232 as defined in FIG. 2.

As discussed in further detail elsewhere herein according to embodiments, the cumulative DNN inference scheme, the confidence level of the cumulative DNN inference result, which may also be referred to as a cumulative confidence level, for the classification task gradually increases, with fluctuations, by combining more DNN inference results over time. The increase in the cumulative confidence level can continue to increase until it reaches a threshold, namely a confidence level requirement, at which point the classification task is completed, namely the task requirements are satisfied.

The illustrated adaptive control framework 300 may be used for cumulative DNN inference of multiple AI tasks in general application scenarios. The framework 300 includes interactions among the network controller 302 and different types of network elements 306, 308, 310, 314 for AI task i, and simplifies interactions for other AI tasks. For each AI task, there can be multiple Type-A network elements 306 and Type-B network elements 308 and there can be one Type-D network element 314, which may be different from the corresponding network elements for other AI tasks. The framework 300 can also include a Type-C network element 310, which can be shared by multiple AI tasks 304, where the computing resources for enhanced DNN inference are shared among multiple AI tasks. Several potential specific scenarios are described herein, which are simplified example scenarios for illustrative purposes under the general framework 300 described here.

According to embodiments, the network controller 302 can transmit a data request 340 to a Type B network element 308 and to a Type A network element 306. This data request 340 may be considered to be the same or similar to the data request 206 as illustrated in FIG. 2. It will be readily understood that the data request transmitted to the Type B network element 308 and to a Type A network element, may or may not be the same or similar in content therein, but would be configured to be suitable for and understandable by the respective network element to which it is transmitted and received thereby.

According to embodiments, the network controller 302 can transmit an enhanced inference request 344 to a Type B network element 308 and to a Type C network element 310. This enhanced inference request 344 may be considered to be the same or similar to the enhanced inference request 222 as illustrated in FIG. 2. It will be readily understood that the enhanced inference request transmitted to the Type B network element and to a Type C network element, may or may not be the same or similar in content therein, but would be configured to be suitable for and understandable by the respective network element to which it is transmitted and received thereby.

According to embodiments, the Type B network element can transmit one or more sample of intermediate data 342 to a Type C network element 310 wherein these one or more samples of intermediate data are provided in order for the Type C network element to determine an enhanced DNN inference. The one or more samples of intermediate 342 may be considered to be the same or similar to the one or more samples of intermediate data 226 as illustrated in FIG. 2. It will be readily understood that while the intermediate data has been defined as the same or similar, it is apparent that the actual numerical information in the intermediate data may be different and that the purpose or application of the intermediate data can be considered to be the same or similar.

In some embodiments, the controller is configured to determine whether a cumulative DNN inference is to be performed. For example, if the network controller 302 determines that a full DNN inference is sufficient (i.e. meets the confidence level requirement of the AI task), for example based on task requirement and/or confidence level requirement, the network controller 302 may inform, by for example transmitting a notification, the Type-B network element 308 and the Type-D network element 314 of the sufficiency of the full DNN inference. For example, in some instances this notification may be considered as a sufficiency notification. Upon receipt of the notification, the Type B network element 308 will not perform or will cease performing a fast DNN inference (i.e. determining a fast DNN inference result). In addition, upon receipt of the notification, the Type D network element 314 will not perform or will cease performing a cumulative inference (i.e. determining a cumulative inference result). In some embodiments, a notification indicating or instructing to cease the fast DNN inference or the cumulative inference is respectively sent to the Type-B network element 308 and the Type-D network element 314, and the Type-B network element 308 and the Type-D network element 314 according to the notification will respectively not perform or cease performing the fast DNN inference or the cumulative inference. It will be readily understood that the notification sent to the Type-B network element 308 may be the same as or similar to, or different from the notification sent to and the Type-D network element 314 in configuration and/or information therein, and that each of these notifications will have information or instructions which is suitable for and understandable by the respective network element to which it is transmitted and received thereby.

For example, in order to provide a level of continuity between FIG. 2 and FIG. 3 the intelligent IoT device 210 of FIG. 2 can be considered to be similar to Type A network elements 306, Type B network elements 308 and Type C network elements 310 illustrated in FIG. 3. In addition, data source 212 of FIG. 2 can be considered to correspond to Type A network elements 306 of FIG. 3, Furthermore, the fast DNN inference 214 of FIG. 2 can be considered to correspond with a Type B network element 308 of FIG. 3, In addition, the application layer 220 of FIG. 2 can be considered to correspond with the application layer 312 of FIG. 3

For further continuity between FIG. 2 and FIG. 3, the controller 204 can be considered to correspond with the network controller 302, the enhanced DNN inference 224 can be considered to correspond to the Type C network element 310.

According to embodiments, having further regard to FIG. 2, for each intelligent IoT device i 210 which initiates an AI task there is an associated enhanced DNN inference for device i 224. The controller 204 coordinates multiple AI tasks, wherein each of these AI tasks are initiated by a different intelligent IoT device 210.

According to embodiments and having regard to FIG. 3, each AI task has an associated Type A network element 306, Type B network element 308, Type C network element 310 and an associated application layer 312 (which is in Type D network element 314). The network controller 302 is configured to coordinate multiple AI tasks.

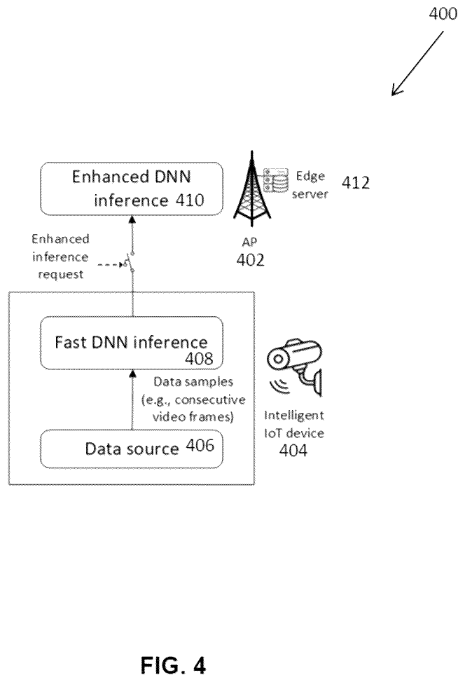

FIG. 4 illustrates a single-sensor application scenario 400 with a single access point 402, according to an aspect of the present disclosure. This scenario 400 includes a single-sensor application scenario where an intelligent IoT device 404 (such as a smart camera) provides the fast DNN inference functionality 408 for multiple consecutive data samples (such as video frames) generated by the locally embedded data source 406. The enhanced DNN inference module 410 in this scenario 400 is placed at an AP 402 associated with an edge server 412. In this scenario 400, the IoT device 404 serves as both a Type-A and a Type-B network element, acting as both a data source 406 and a fast DNN inference module 408, and the AP 402 serves as Type-C network element, providing an enhanced DNN inference module 410.

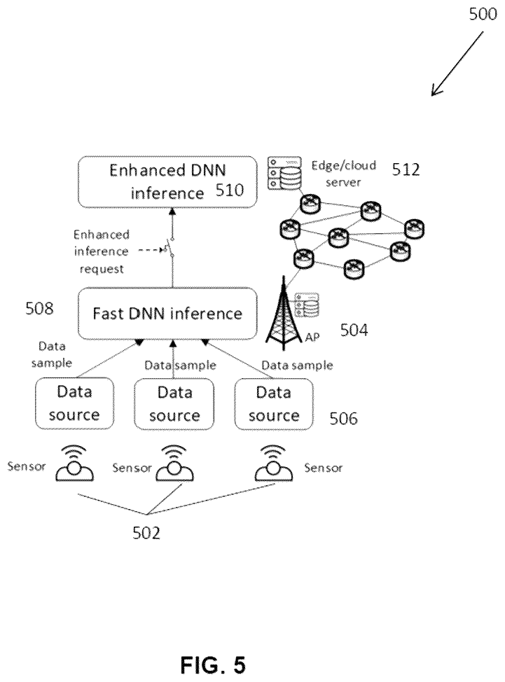

FIG. 5 illustrates a multi-sensor application scenario 500 with multiple sensors 502 under the coverage of a single access point 504, according to an aspect of the present disclosure. In this scenario 500, each of multiple sensors 502 act as data sources 506 and the fast DNN inference module 508 is placed at the AP 504. As positioned, the fast DNN inference module 508 can collect data samples from each of the multiple data sources 506, which are the sensors 502 in this scenario 500. The sensors 502 may each provide data samples for the same AI task. The enhanced DNN inference module 510 may be placed at a remote edge or cloud server 512, which can be accessed via a transport network. In this scenario 500, there are multiple Type-A network elements which are the sensors 502, one Type-B network element which is the AP 504, and one Type-C network element which is the remote edge/cloud server 512.

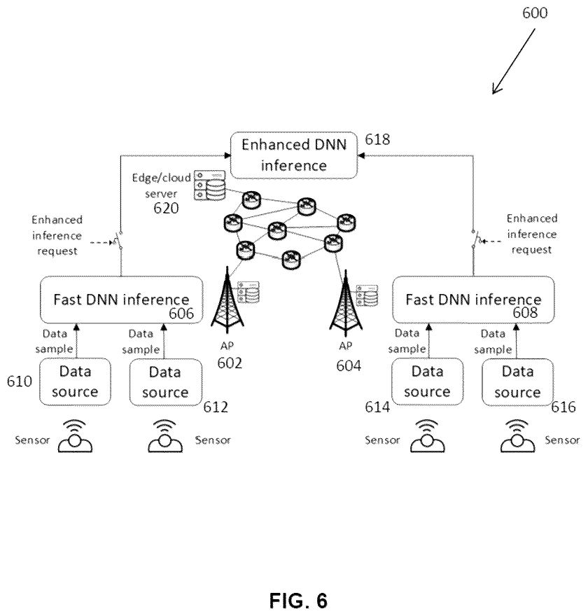

FIG. 6 illustrates a multi-sensor application scenario 600 with multiple data sources and multiple access points 602, 604, according to an aspect of the present disclosure. This scenario 600 may be thought of as a generalization of scenario 500, with the addition of further access points 602, 604 and further data sources 610, 612, 614, 616. This scenario 600 includes two access points 602, 604 and can include further access points as well. Each of the access points 602, 604 includes a fast DNN inference module 606, 608. The access points 602, 604 may each communicate with one or more data sources 610, 612, 614, 616. For example, access point 602 may be configured to receive data from data source 610 and data source 612, while access point 604 may be configured to receive data from data source 614 and data source 616. The enhanced DNN inference module 618 may be placed at a more powerful remote edge or cloud server 620, which can be accessed via a transport network. This scenario 600 includes multiple Type-A network elements, multiple Type-B network elements, and one Type-C network element which is the edge/cloud server 620.

As described, a data-driven stochastic cumulative DNN inference scheme may be used to aggregate the contributions of multiple DNN inference results based on different data samples and different DNN models. The scheme may form a cumulative DNN inference result with potentially improved confidence level and this result can be updated with more aggregated DNN inference results, as those results become available.

The cumulative DNN inference scheme can combine data from multiple DNN inference results. For example, consider J DNN inference results based on either fast or full DNN inference for an M-class classification task. The true class label for the classification task may be unknown. Let zⱼ={z_{j,m}, 1≤m≤M} denote the j-th (1≤j≤J) DNN inference result, which is an M-dimension predicted class probability vector. Let binary parameter χⱼ indicate whether zⱼ is generated by fast or full DNN inference, with χⱼ=1 indicating full DNN inference, and χⱼ=0 otherwise.

Each of the DNN inference results can be assumed to be conditionally independent given the same unknown true class label. For example, with the same unknown true class label, one DNN model may generate conditional independent DNN inference results for different data samples, and different DNN models may generate conditional independent DNN inference results for the same data sample.

Let Z={z₁, . . . , zⱼ} denote the set of DNN inference results up to the j-th DNN inference result. The cumulative DNN inference result, given DNN inference result set Zⱼ, may be defined as an M-dimension predicted class probability vector, denoted by of oⱼ={o_{j,m}, 1≤m≤M}, with o_{j,m}=Pr(Y=m|Zⱼ) representing the predicted conditional probability of class m given DNN inference result set Zⱼ. Based on Bayes' theorem and the conditional independence assumption, o_{j,m} is written as:

$${o}_{j , m} = \frac{Pr ( Y = m ) {\prod }_{{j}^{′} = 1}^{j} Pr ( {z}_{{j}^{′}} \vert Y = m )}{{\sum }_{m = 1}^{M} \{ Pr ( Y = m ) {\prod }_{{j}^{′} = 1}^{j} Pr ( {z}_{{j}^{′}} \vert Y = m ) \}}$$

where Pr(Y=m) represents the prior class distribution, and Pr(z_{j′}|Y=m) represents the conditional joint probability density of the j′-th DNN inference result (i.e., predicted class probability vector z_{j′}) given true class label Y=m. This formula contains:

$$Pr ( {z}_{{j}^{′}} \vert Y = m ) = ( 1 - {χ}_{{j}^{′}} ) {f}_{m}^{A} ( {z}_{{j}^{′}} ) + {χ}_{{j}^{′}} {f}_{m}^{U} ( {z}_{{j}^{′}} )$$

where fₘ^{A}(z_{j′}) denotes the conditional joint probability density of z_{j′} given true class label Y=m if z_{j′} is a fast DNN inference result, and fₘ^{U}(z_{j′}) denotes the conditional joint probability density of z_{j′} given true class label Y=m if z_{j′} is a full DNN inference result.

For the cumulative DNN inference result, of ={o_{j,m}, 1≤m≤M}, a cumulative confidence level may be defined as one minus normalized entropy, as given by:

$${η}_{j} = 1 + {\sum }_{m = 1}^{M} \frac{{o}_{j , m} log {o}_{j , m}}{log M} .$$

Prior to executing a stochastic DNN inference scheme for multiple fast and full DNN inference results, the following initialization steps may be performed.

First, for a training dataset with known class labels Y, the prior class distribution Pr(Y=m) may be estimated for any class m(1≤m≤M).

Next, the training data set may be split into M class-specific training data subsets according to known class labels Y. With each class-specific training data subset, a subset of fast DNN inference results may be collected along with a subset of full DNN inference results. These may be collected by running the fast and full DNN models for each training data respectively.

Finally, we may profile the conditional joint probability density functions (PDF) of fast and full DNN inference results for each class m with the corresponding subset of DNN inference results, i.e., fₘ^{A}(z) and fₘ^{U}(z) for class m, using non-parametric probability density estimation methods such as Kernel density estimation.

These initialization steps may be used prior to a cumulative DNN inference scheme which gradually aggregates J fast or full inference results and updates both a cumulative DNN inference result and a cumulative confidence level at each step j as further discussed in the following steps.

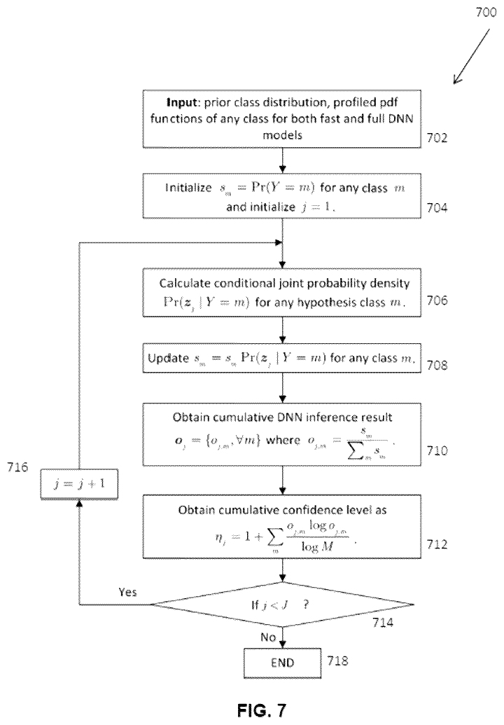

FIG. 7 illustrates a flow chart of a cumulative DNN inference scheme 700 for J fast or full DNN inference results, according to one aspect of the present disclosure. According to embodiments, a cumulative DNN inference scheme for J fast or full DNN inference results, for example as illustrated in FIG. 7, can be implemented within the application layer 312 at the cumulative inference scheme 316 as illustrated in FIG. 3, or by the application layer cumulative DNN inference scheme 220 as illustrated in FIG. 2.

This scheme 700 may be used after the initialization steps described above. At block 702, the cumulative DNN inference scheme 700 includes inputting prior class distribution and the profiled PDF functions of any class for both the fast and the full DNN models.

At block 704, the cumulative DNN inference scheme 700 includes initializing scalar sₘ=Pr(Y=m) for each class m and initializing j=1.

At block 706, the cumulative DNN inference scheme 700 includes calculating conditional joint probability density Pr(zⱼ|Y=m), the conditional joint probability density of the j-th DNN inference result zⱼ, for each class m. Depending on whether zⱼ is a fast DNN inference result or a full DNN inference result, this may use either fₘ^{A}(z) or fₘ^{U}(z) as the PDF function for class m. Specifically, this may calculate Pr(zⱼ|Y=m)=(1−χⱼ)fₘ^{A}(zⱼ)+χⱼfₘ^{U}(zⱼ) for class m, where binary parameter χⱼ indicates whether the result is fast or full, as described above.

At block 708, the cumulative DNN inference scheme 700 includes updating scalar sₘ=sₘPr(zⱼ|Y=m) for each class m.

At block 710, the cumulative DNN inference scheme 700 includes obtaining cumulative DNN inference result given Zⱼ, i.e., oⱼ={o_{j,m}, ∀m} where

$${o}_{j , m} = \frac{{s}_{m}}{{\sum }_{m} {s}_{m}} .$$

At block 712, the cumulative DNN inference scheme 700 includes obtaining cumulative confidence level given Zⱼ as

$${η}_{j} = 1 + {\sum }_{m = 1}^{M} \frac{{o}_{j , m} log {o}_{j , m}}{log M} .$$

At block 714, the cumulative DNN inference scheme 700 includes checking whether j<J. If so, at block 716, the cumulative DNN inference scheme 700 includes increasing j by 1, and repeating blocks 706, 708, 710, 712, and 714. Otherwise, if j=J, the cumulative DNN inference scheme 700 ends at block 718.

According to some embodiments, the cumulative DNN inference scheme can improve the confidence level for AI classification tasks by aggregating multiple inference result and it can be robust to non-frequent false inference especially when the number of aggregated inference results is larger. The confidence level metric can evaluate the uncertainty or information entropy in a DNN inference result. A larger confidence level can be considered to have a lower uncertainty (less information entropy) in the predicted class probability vector. As such the accuracy of AI classification, which evaluates the average percentage of correct classification, can be improved by the cumulative DNN inference scheme, as the uncertainty in the prediction for the true class can be reduced by improving the confidence level of cumulative inference result.

In the considered device-edge co-inference framework with cumulative DNN inference for multiple network entities or network elements, each initiating an AI task, the update of cumulative confidence levels during time slot k depends on the offloading decisions during the time slot. Specifically, the cumulative confidence level of network entity i at the beginning of time slot k+1, denoted as ηᵢ(k+1), is updated based on the proposed cumulative DNN inference scheme by aggregating either one new fast inference result for aᵢ(k)=0 or a number of aᵢ(k) new full inference results for aᵢ(k)>0 with all the past inference results at device i from the start of the AI task.

An adaptive control scheme may be used with cumulative DNN inference of multiple AI tasks. The adaptive control scheme may seek to improve confidence levels and reduce delays for AI tasks, while improving both energy and network resource efficiency.

For example, consider that each network entity in a network initiates an AI classification task at the beginning of time slot k=1, with delay requirement Kᵢ in number of times slots for network entity i. If the confidence level requirement, η_{T}, is satisfied at or before time slot Kᵢ, the task of network entity i is successfully finished and the quality-of-service (QoS) requirement is satisfied. Otherwise, the cumulative DNN inference continues for network entity i until the confidence level is satisfied, in which case a delay violation penalty may be applied to the network entity, as defined as follows.

As discussed in further detail elsewhere herein according to embodiments, the cumulative DNN inference scheme, the confidence level of the cumulative DNN inference result, which may also be referred to as a cumulative confidence level, for the classification task gradually increases, with fluctuations, by combining more DNN inference results over time. The increase in the cumulative confidence level can continue to increase until it reaches a threshold, namely a confidence level requirement, at which point the classification task is completed. Having regard to FIG. 2, these details relating to the task requirements 234 are transmitted from the application layer 220 to the controller 204. Having regard to FIG. 3, these details relating to the task requirements 326 are transmitted from the application layer 312 to the network controller 302.

As discussed in further detail elsewhere herein, according to embodiments, the delay requirement is a value, which defines a delay threshold for the classification task. If the confidence level requirement is satisfied before or at a delay threshold, the classification task is considered to be successful with a satisfactory QoS. Otherwise, there is a delay violation penalty applied to the corresponding network entity which initiated the classification task. An example of a delay requirement can be 100 ms, is or other time period which may be determined based on the application layer's requirement. Having regard to FIG. 2, these details relating to the task requirements 234 are transmitted from the application layer 220 to the controller 204. Having regard to FIG. 3, these details relating to the task requirements 326 are transmitted from the application layer 312 to the network controller 302.

Let Pᵢ(k) denote the delay violation penalty of network entity i at the end of time slot k. The penalty Pᵢ(k) is zero for 1≤k<Kᵢ, as the deadline for network element i has not been reached. For k≥Kᵢ, if the current cumulative confidence level does not reach the required confidence level threshold η_{T}, such that ηᵢ(k)<η_{T} for network element i, the penalty Pᵢ(k) may increase linearly with the number of time slots behind deadline. For example, P may be a constant denoting the unit penalty for each time slot with delay violation. Thus, the delay violation penalty may be calculated as:

$${P}_{i} ( k ) = \{ \begin{matrix}{( k - {K}_{i} + 1 )}^{+} P , & if {η}_{i} ( k ) < {η}_{T} \\ 0 , & otherwise .\end{matrix}$$

The delay violation penalty Pᵢ(k) of network element i for k≥Kᵢ depends on all the offloading decisions from time slot 1 to time slot k, as the sequence of offloading decisions determines the total number of fast and full DNN inference results obtained for network entity i until time slot k. To improve the confidence level performance within given delay requirement and reduce the delay violation penalty, it may be preferable to execute full DNN inference rather than fast DNN inference, i.e., offloading is preferred than local computing for QoS improvement, as full DNN inference provides higher confidence level gain on average. However, as an example offloading may lead to more network resource consumption in terms of transmission and edge computing. Moreover, also as an example, local energy consumption should also be considered, as some IoT devices may be battery powered and thus energy limited. Also, there are potential trade-offs between local energy consumption and network resource consumption. As the intermediate data size is usually small, the local transmission energy for offloading one intermediate data sample to obtain one full inference result is usually smaller than the local computing energy for fast DNN inference. The network resource consumption cost and energy consumption cost are formally defined as follows.

The adaptive control scheme may seek to measure and limit network resource consumption cost. Let βᵢ(k) denote the fraction of uplink transmission resource usage for offloading aᵢ(k) intermediate data samples from network element i to a Type C network element. Let [symbol] (k) denote the fraction of edge computing resource usage at the Type C network element for enhanced DNN inference of the aᵢ(k) offloaded intermediate data samples from network element i. Let ρ(k) denote the network resource consumption cost during slot k, which is the maximum between the total fraction of uplink transmission resource usage, [symbol] βᵢ(k), and the total fraction of edge computing resource usage, [symbol] (k), for all devices in set [symbol] during time slot k.

The adaptive control scheme may seek to measure and limit energy resource consumption cost. Let eᵢ(k) denote the energy consumption at network element i during time slot k, which is either the transmission energy for offloading aᵢ(k) intermediate data samples from network element i to the Type C network element, or the computing energy for one fast DNN inference at network element i. The total energy consumption cost at all network elements in set [symbol] during time slot k is e(k)= [symbol] eᵢ(k).

The adaptive control scheme may seek to characterize the trade-off between local energy consumption and network resource consumption. For example, this cost may be denoted by c(k) as a linearly weighted summation of the total local energy consumption cost and the network resource consumption cost during slot k, given by

$$c ( k ) = {ω}_{1} e ( k ) + ( 1 - {ω}_{1} ) ρ ( k )$$

with weighting factor ωᵢ∈ (0,1).

According to embodiments, the adaptive control scheme can be executed by the controller 204 in FIG. 2 or the network controller 302 in FIG. 3.

The adaptive control scheme may look to trade-off between using less local energy but more network resources to offload an intermediate data and obtaining a full inference result with higher confidence level, or using more local energy but no network resources to process a new data sample and obtaining a fast inference result with lower confidence level.

Therefore, the adaptive control scheme may be configured to adaptively make offloading decisions for devices with efficient resource allocation among devices. The scheme may seek to minimize the long-run total cost in terms of network resource and local energy consumption and the total delay violation penalty until all the tasks are finished with confidence level satisfaction.

To support the offloading decisions for the devices during time slot k, i.e., aₖ={aᵢ(k), ∀i∈ [symbol] }, the uplink transmission resources between the devices and the AP and the edge computing resources at the AP may be allocated among the network elements in set [symbol] , to ensure that the aᵢ(k) intermediate data samples can be transmitted from network element i to the Type C network element and finish the enhanced DNN inference at the Type-C network element within time slot duration r under the resource capacity constraints if aᵢ(k)>0, with the minimum cost in term of energy consumption at the devices and network resource consumption. An optimal resource allocation can be obtained using traditional optimization techniques. The details of the resource allocation optimization problem are neglected. Let c*(k) denote the minimal cost with optimal resource allocation given offloading decision vector aₖ={aᵢ(k), ∀i∈ [symbol] in time slot k. The sequence of offloading decisions over consecutive time slots can be made using a Markov decision process for adaptive offloading decision.

To minimize the total cost and total delay violation penalty in the long run, the adaptive control scheme may adaptively determine the offloading decisions during the cumulative DNN inference for the AI tasks of multiple network elements. These adaptive offloading decisions may be formulated as a Markov decision process. The state sₖ, action aₖ, and reward rₖ in the Markov decision process are formally defined as follows.

For time slot k, the adaptive control scheme may be configured to consider the current caching state at each device, q(k)={qᵢ(k), ∀ᵢ∈ [symbol] , as the number of samples of intermediate data offloaded from a network element should not exceed the number of samples of intermediate data currently stored in the local cache. The adaptive control scheme may also consider the current cumulative confidence level at each network element, η(k)={ηᵢ(k), ∀i∈ [symbol] }, and the current time slot index, k. Given the delay requirement Kᵢ for device i, the remaining number of time slots before deadline is known at time slot k. It may be more beneficial to offload more intermediate data from a network element whose current cumulative confidence level is low and remaining time to deadline is short, to reduce the potential delay violation penalty. Hence, the state for time slot k, denoted by sₖ, can be composed of three parts: caching state q(k), current cumulative confidence levels η(k), and current time slot index k, represented as sₖ=[q(k), η(k), k]. At the beginning of an episode, the state can be initialized as s₁=[q(1), η(1), 1]=[0, 0, 1]. At the end of time slot k, the state can then be updated as sₖ₊₁=[q(k+1), η(k+1), k+1]. Both the caching state and the time slot index can be updated inside the network controller, while the cumulative confidence levels can be updated from the application-layer cumulative DNN inference modules for each network element.

The action at time slot k is the offloading decision vector aₖ={aᵢ(k), ∀i∈ [symbol] }. Let [symbol] denote the action space, which corresponds to a set of feasible offloading decisions under network resource availability. The adaptive control scheme may predetermine the action space by checking the feasibility of a resource allocation optimization problem given each candidate offloading action.

For adaptive offloading in cumulative DNN inference, the adaptive control scheme may be configured to jointly consider the cost and QoS performance. Let rₖ denote the reward during slot k, which incorporates both minimal cost c*(k) with optimal resource allocation and delay violation penalty Pᵢ(k), given by

$${r}_{k} = - exp ( {ω}_{2} {c}^{*} ( k ) ) - {\sum }_{i ∈ 𝒥} {P}_{i} ( k )$$

where ω₂ is a positive weighting factor. In the expression of rₖ, the adaptive control scheme uses an exponential function to increase the cost gaps among different offloading decisions and make reward rₖ more sensitive to offloading decision.

According to embodiments, the adaptive control framework for cumulative DNN inference of multiple AI tasks can substantially maximize the energy and resource efficiency with a substantially minimum delay violation penalty for the cumulative confidence level satisfaction of all AI tasks. As the network resources can be shared among multiple AI tasks, the selection between fast and full DNN inference and the number of samples of intermediate data offloaded can be adaptively determined for each AI task, while including the consideration of dynamics in the current cumulative confidence levels, the caching state, and the remaining time to the deadline for different AI tasks. The AI model deployment with layer sharing between the fast and full DNN models can enable the reuse of intermediate data of the fast DNN inference for generating a new full inference result. This may improve the computation efficiency for obtaining full inference results. Hence, the resource efficiency of the cumulative DNN inference for AI tasks can be further enhanced by using the computation-efficient AI model deployment strategy.

According to embodiments, there is provided a deep Q learning algorithm with extra experience replay. The Markov decision process for adaptive offloading decision can be solved using a reinforcement learning (RL) approach. The goal is to find a policy, π(s), mapping a state to an action, to maximize the expected cumulative discounted reward [symbol] (Σₖ₌₁^{K}γ^{k}rₖ) where [symbol] denotes expectation, K is the maximum number of time slots in an episode, and γ∈(0,1) is the discount factor. As the offloading actions are discrete, a modified deep Q learning algorithm based on the basic deep Q learning algorithm can be used to solve the Markov decision process. In deep Q learning, a state-action value function (i.e., Q function) can be defined as:

$$Q ( {s}_{k} , {a}_{k} ) = 𝔼 ( {\sum }_{{k}^{′} = k}^{K} {γ}^{{k}^{′} - k} {r}_{k} \vert {s}_{k} , {a}_{k} )$$

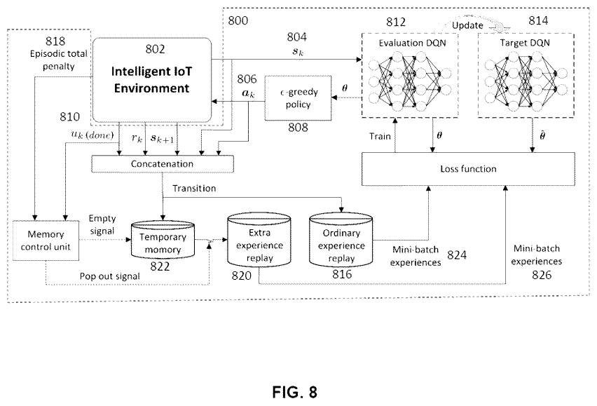

FIG. 8 illustrates a modified deep Q learning scheme, according to an aspect of the present disclosure. It is understood that FIG. 8 illustrates an example scenario in accordance with an embodiment of the present disclosure.

Having regard to FIG. 8, elements of the modified deep Q learning scheme includes the consideration of episodes, interaction between the RL agent and the environment, the done signal, evaluation and target deep Q networks (DQNs) and learning from transitions in experience replay. The modified deep Q learning scheme further includes the consideration of episode level penalty and episodic total penalty flag, extra experience replay, temporary memory and learning from transitions in both ordinary and extra experience replays.

Having regard to episodes, consider that an RL agent interacts 800 with the intelligent IoT environment 802 with the device-edge co-inference framework for cumulative DNN inference of multiple devices in a sequence of episodes. Each episode contains a finite and variable number of learning steps, wherein there can be one learning step for one time slot. An episode starts when the devices initiate a new group of AI tasks whose confidence levels are initialized as 0 and ends when the last device finishes its task with confidence level satisfaction. At the beginning of a new episode, the time slot index k is initialized to 1.

Having regard to the interaction between the RL agent 800 and the intelligent IoT environment 802, within an episode, the RL agent observes state sₖ 804 and takes action aₖ 806 at the beginning of each time slot k. The deep Q learning uses an ε-greedy policy 808 for action selection for exploitation, with ε representing the exploration probability. With probability 1-ε, the action with the maximum Q value at state sₖ is selected, i.e.,

$${a}_{k} = {arg max}_{a} Q ( {s}_{k} , a ) ;$$

with probability ε, a random action is selected. At the end of time slot k, the RL agent receives reward rₖ from the intelligent IoT environment 802, and transits to new state sₖ₊₁.

Having regard to the done signal, for example uₖ can be defined as a binary flag indicating if time slot k is the last time slot in the corresponding episode. If uₖ=1, the episode terminates at time slot k, and a done signal (uₖ (done) 810) is generated by the intelligent IoT environment 802. As previously discussed, an episode terminates if all the tasks of different devices are finished with confidence level satisfaction. The number of time slots (K) in an episode can be smaller than

$${max}_{i ∈ 𝒥} {K}_{i}$$

if all tasks are finished before the required deadlines, in which case there is no delay violation penalty in the episode. It can also be larger than

$${max}_{i ∈ 𝒥} {K}_{i}$$

when there is delay violation penalty. Hence, K is a variable which may take different values in different episodes.

Having regard to the evaluation and target deep Q networks (DQNs), the deep Q-learning can adopt two deep Q networks (DQNs) with the same neural network structure as Q function approximators, i.e., evaluation DQN with weights θ 812 and target DQN with slowly updated weights \hat{θ} 814. Every K_{θ} learning steps, \hat{θ} is replaced by θ. The approximated Q functions by the evaluation and target DQNs are represented as Q(sₖ, aₖ; θ) and \hat{Q}(sₖ, aₖ; \hat{θ}), respectively.

Having regard to learning from transitions in experience replay, at the end of time slot k, a new transition (sₖ, aₖ, rₖ, sₖ₊₁, uₖ) is added to a replay memory in the deep Q learning algorithm. Here, we refer to such a replay memory being updated per learning step as the ordinary experience replay 816. Traditionally, at each learning step k, an evaluation DQN with weights θ is trained with a mini batch of N transitions (also referred to as experiences) sampled from the ordinary replay memory. The n-th sampled experience is (sₙ, aₙ, rₙ, sₙ₊₁, uₙ). The evaluation DQN is trained by minimizing a loss function, defined as follows:

$$ℒ ( θ ) = 𝔼 [ {( {y}_{n} - Q ( {s}_{n} , {a}_{n} ; θ ) )}^{2} ]$$

for all the sampled N transitions through gradient descent on θ, where yn is a target value estimated by target DQN, which can be defined as follows:

$${y}_{n} = \{ \begin{matrix}{r}_{n} + γ {arg max}_{a} \hat{Q} ( {s}_{n + 1} , a ; \hat{θ} ) , & if {u}_{n} = 0 \\ {r}_{n} , & if {u}_{n} = 1.\end{matrix}$$

A gradient descent on θ can be performed as follows:

$$θ ← θ + α𝔼 [ ( {y}_{n} - Q ( {s}_{n} , {a}_{n} ; θ ) ) {∇}_{θ} Q ( {s}_{n} , {a}_{n} ; θ ) ]$$

where α is the learning rate.

Having regard to the episode-level penalty and episodic total penalty flag, the delay violation penalty Pᵢ(k) for device i always equals zero before deadline Kᵢ. Only for k≥Kᵢ close to the end of an episode, Pᵢ(k) may have positive values. However, Pᵢ(k) for k≥Kᵢ depends on all transitions from the beginning of the current episode (i.e., time slot 1) to time slot k. A penalty with such a property can be defined as an episode-level penalty. To indicate whether the QoS requirements of the AI tasks of all devices are satisfied or not, there is defined an episodic total penalty flag 818, which is set to 0 if all the transitions in an episode have no delay violation penalty and set to 1 otherwise. The episodic total penalty flag is set by the environment at the end of an episode.

Having regard to the extra experience replay, an episode with QoS satisfaction for all devices (i.e., with zero episodic total penalty flag) can be rare, especially at the early learning stage. Consequently, the sampling frequency for transitions in such zero-penalty episodes from the ordinary experience replay can be low, especially if the replay memory capacity is large. However, these rare transitions can be good transitions which can help the RL agent to learn how to satisfy the confidence level requirements without a delay violation penalty. To increase the sampling frequency for such good transitions and deal with the episode-level penalty, there is provided an extra replay memory 820. Specifically, all the transitions in a whole episode can be stored in an extra replay memory if the episodic total penalty flag is zero.

Having regard to the temporary memory 822, the storage mechanism for the extra replay memory 820 can be enabled by a temporary memory 822 which stores the transitions at each learning step and empties out before each new episode. If the episodic total penalty flag is zero at the end of an episode, all the transitions in the temporary memory 822 are popped out and stored in the extra replay memory 820. Otherwise, all the transitions in the temporary memory 822 are discarded.

Having regard to learning from transitions in both ordinary and extra experience replays, with the extra experience replay memory 820, a mini-batch of N experiences 824 are sampled from the ordinary replay memory 816 and another mini-batch of N experiences 826 are sampled from the extra experience replay memory 820 at each learning step. The evaluation DQN is trained twice at each learning step, first trained with the N sampled experiences 824 from the ordinary replay memory 816, and then trained with the N sampled experiences 826 from the extra experience replay memory 820.

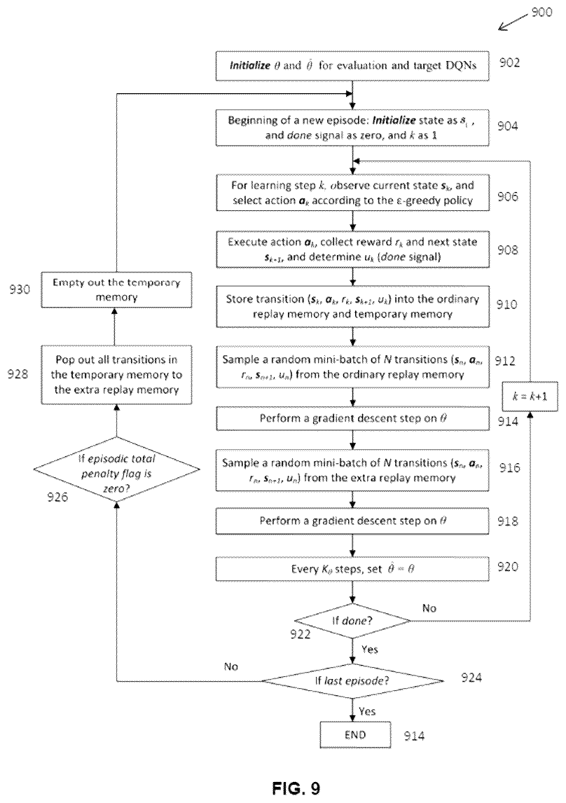

FIG. 9 illustrates a flow chart of a deep Q learning scheme 900 with extra experience replay, according to an aspect of the present disclosure. According to embodiments, a Deep Q learning scheme with extra experience replay, for example as illustrated in FIG. 9, can be implemented by the controller 204 as illustrated in FIG. 2 or by the network controller 302 as illustrated in FIG. 3.

At block 902 initialization occurs, wherein \hat{θ} and θ are initialized for the target DQN and the evaluation DQN respectively. At block 904 a new episode begins with the initialization of the state as s₁ and the done signal is set to zero and k is set to 1. As block 906 for learning step k, sₖ is observed and action aₖ is selected according to an ε-greedy policy. At block 908 action aₖ is executed a reward rₖ is collected. The transition to the next state sₖ₊₁ occurs together with the determination of uₖ (done) signal. At block 910 transition (sₖ, aₖ, rₖ, sₖ₊₁, uₖ) is stored in the ordinary experience replay memory and the temporary memory.

At block 912 a random mini-batch of N transitions (sₙ, aₙ, rₙ, sₙ₊₁, uₙ) is sampled from the ordinary experience replay memory and at block 914 a gradient descent on step θ is performed. At block 916 a random mini-batch of N transitions (sₙ, aₙ, rₙ, sₙ₊₁, uₙ) is sampled from the extra experience replay memory and at block 918 a gradient descent on step θ is performed. At block 920 for every K_{θ} steps, \hat{θ} is set equal to θ. At decision 922, if the uₖ (done) signal is equal to 1, subsequent decision 924 is made to determine if it is the last episode. If decision block 924 is yes the process ends, however if decision block 924 is no, at decision 926 if the episode total penalty is zero, the process moves to block 928 where all transitions in the temporary memory are popped out to the extra experience replay memory and at block 930 the temporary memory is emptied. The process then moves to block 904. However, if decision 922 is no, k is set to k+1 and the process moves to block 906.

According to embodiments, an episode with QoS satisfaction for all devices (i.e., with all transitions in the episode having no penalty) can be rare, especially at the early learning stage. Given extra experience replay can store the transitions in episodes with no penalty, the sampling frequency for such good transitions can be improved, and the RL agent has more opportunities to learn from these good transitions, and this may help the RL agent to converge towards a good solution with negligible delay violation penalty.

According to embodiments a simulation according to embodiments of the instant disclosure is performed, wherein the simulation setup is considered where an edge-assisted intelligent IoT scenario has three intelligent IoT devices under the coverage of one AP. The AP is co-located with an edge server. The system parameters are given in TABLE 1. It is assumed that each of the devices have identical noise power, transmit power, uplink channel gain, computing capability, and energy efficiency.

TABLE 1

| Parameters | Value | |
|---|---|---|
| Bandwidth (B) | 15 | MHz |
| Noise power (σ²) | −104 | dBm |
| Transmit power (pᵢ) | 20 | dBm |
| Channel gain (gᵢ) | 4 × 10⁻¹³ | |
| Local CPU frequency (fᵢ) | 0.45 | GHz |
| Edge server CPU frequency (f₀) | 20 | GHz |

| | |
|---|---|
| Energy efficiency coefficient (κᵢ) | 10⁻²⁸ |
| Number of CPU cycles for each floating-point | 4 |
| operation (φ₁) | |
| Number of bits to represent a floating-point | 32 |
| number (φ₂) | |

For this simulation, a video classification application scenario is considered, where an AI classification task is to classify a moving object under the surveillance of the smart camera. A typical video dataset UCF101 which has been integrated in Tensorflow has been considered. The video dataset contains videos capturing moving objects belonging to 101 different classes. Five classes of video data are selected among all the 101 classes, and the 5-class small video dataset are denoted as UCF5. For each video in the UCF5 dataset, multiple consecutive frames are extracted with a frame sampling rate equal to 5 frames per second (fps). Hence, corresponding to the UCF5 video dataset, there is obtained a 5-class image dataset including all the extracted video frames. Then, for each AI classification task, there are multiple available data samples, which correspond to all the extracted frames of a randomly selected video belonging to an unknown class in the UCF5 video dataset.

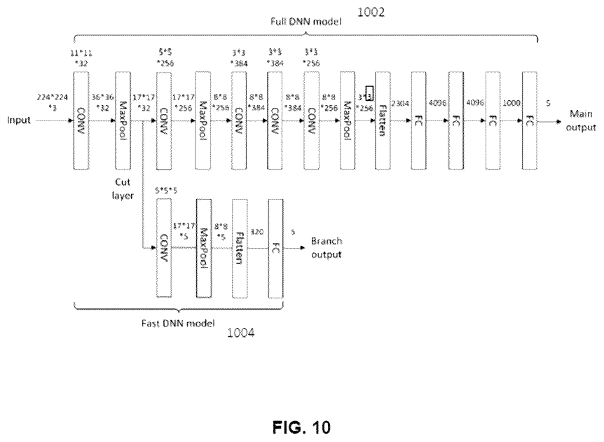

The fast DNN model 1004 and the full DNN model 1002 which share the first few layers is illustrated in FIG. 10. Without loss of generality, the same DNN models are considered for all devices. The full DNN model 1002 includes five CONV layers, three of which are followed by a MaxPool layer for data dimension reduction. The 3D output feature map of the last MaxPool layer is flatten to a 1D input to a sequence of FC layers. The fast DNN model 1004 includes two CONV layers, two MaxPool layers, and one FC layer in total. The fast DNN model 1004 shares the first group of CONV and MaxPool layers with the full DNN model 1002. Due to the layer sharing property, the fast DNN model 1004 and the full DNN model 1002 can be seen as a combined DNN model with one branch. The main and branch outputs in the combined DNN model denote the full and fast DNN model outputs, respectively. In the combined DNN model, all the CONV and FC layers except the last FC layers before each output are activated with Relu activation function. The last FC layers are activated with Softmax activation function, to generate a non-negative output probability vector which adds up to one at each output. The input and output dimensions for each layer are indicated in FIG. 10. Both the main and branch outputs correspond to a predicted class probability vector with 5 elements. The filter number and size for each CONV layer is indicated. For example, the first CONV layer has 32 square filters with size 11×11. To prepare for DNN inference, the combined DNN model is trained by minimizing the combined loss of both the main and branch outputs based on the 5-class image dataset.

Given the DNN layer parameters, both the communication and computing resource demands for DNN inference can be determined. With the simulation parameters as defined in TABLE 1, the time slot length is set equal to the local computing delay for one fast DNN inference as τ=0.288 s. At most two intermediate data samples can be offloaded to the edge server and finishing of the enhanced DNN inference during one time slot. The action space for the deep Q learning algorithm includes 10 discrete offloading actions, i.e., (0, 0, 0), (0, 0, 1), (0, 0, 2), (0, 1, 0), (0, 1, 1), (0, 2, 0), (1, 0, 0), (1, 0, 1), (1, 1, 0), (2, 0, 0). With the small action space, the minimal cost for each candidate offloading action can be pre-calculated by solving a resource allocation optimization problem. Then, the minimal costs can be used in the reward calculation at each learning step in the deep Q-learning algorithm for adaptive offloading decision. The evaluation and target deep Q networks both have three hidden layers with (128, 64, 32) neurons between the input and output layers. The activation function for each hidden layer is Relu. Other learning parameters are summarized in TABLE 2. The weighting factor ω₂=30 and unit penalty P=400 in the reward function are set.

TABLE 2

| Learning parameters | Value |
|---|---|
| Learning rate (α) | 10⁻⁴ |
| Discount factor (γ) | 0.85 |
| Minimum exploration probability (∈₀) | 0.01 |
| Decaying factor for exploration probability (Δ_{∈}) | 0.9995 |
| Number of steps to replace \hat{θ} by θ (K_{θ}) | 200 |
| Memory size | 2000 |
| Batch size (N) | 32 |

With the trained fast and full DNN models, two sets of DNN inference results are obtained with the 5-class image dataset extracted from the UCF5 video dataset, which include fast and full inference results, respectively. With known class labels for each image in the training dataset, the joint probability density functions (pdfs) of fast and full DNN inference results are profiled and given each true class label m, i.e., fₘ^{A}(z) and fₘ^{U}(z). The kernel density estimation method in Matlab to profile the pdf functions can be used. Subsequently the cumulative DNN inference scheme according to embodiments can be performed.

For this example, there are approximately 600 videos in the UCF5 video dataset. For each video, J=50 video frames are randomly selected as available data samples for the cumulative DNN inference. As different data samples with the same true class label generate conditionally independent DNN inference results, the J data samples are reordered for each video by 100 times, to create 100 different sequences of data samples based on each video. A sequence of data samples can be referred to as a data trace. Each data trace corresponds to an AI classification task. As such, 60000 AI classification tasks with different data traces for cumulative DNN inference can be simulated. It is noted that the video frames are not disordered for cumulative DNN inference in a real intelligent IoT scenario. In this example, the video frames are disordered in order to simulate more data traces.

Cumulative confidence level: For this example, the cumulative confidence level can be determined and the relationship between the cumulative confidence level and the number of data samples is evaluated. The experiments for full and fast DNN inference are performed separately. For example, in the experiments with full DNN inference, all the J data samples in each data trace are processed by the full DNN model, and the corresponding J full inference results are aggregated based on the cumulative DNN inference scheme.

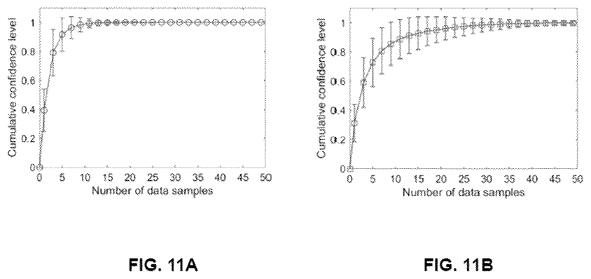

FIG. 11A illustrates a relationship between a cumulative confidence level and a number of data samples for a full DNN inference, according to the simulation according to FIG. 10. FIG. 11B illustrates a relationship between a cumulative confidence level and a number of data samples for a fast DNN inference, according to the simulation according to FIG. 10. The standard deviations of the results are also plotted for reference. A data point represents the mean value of cumulative confidence levels for all data traces at a given number of data samples. It can be observed that the average cumulative confidence level shows an increasing trend with more data samples and gradually approaches one for both the full and fast DNN inference. The increasing speed with full DNN inference is higher, demonstrating that the average confidence level gain with one more full inference results is larger than that with one more fast inference result. The average confidence level gain per inference shows a decreasing trend and gradually approaches zero. The standard deviation of cumulative confidence levels can be considered as large especially at low numbers of data samples, which gradually decreases and approaches zero with more data samples. The decreasing speed in standard deviation is higher with full DNN inference. The large standard deviation captures the uncertainty in cumulative DNN inference, which is due to randomness in the DNN inference results in terms of confidence level and accuracy. As the cumulative DNN inference scheme sequentially incorporates each data sample in a data trace and each data sample corresponds to a different DNN inference result with randomness, the relationship between the cumulative confidence level and the number of data samples changes for different data traces.

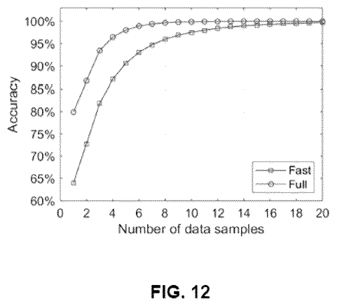

In addition to the confidence level performance metric, an accuracy performance metric is determined for the AI classification tasks, with the cumulative DNN inference scheme. During the AI inference stage, the true class labels are unknown, and the AI classification application relies on the DNN inference results which can be false. As previously noted, the cumulative confidence level gradually increases with possible fluctuations as the number of data samples increases. However, as the confidence level represents uncertainty in a DNN inference result rather than the accuracy thereof, a single DNN inference result with high confidence level is still possible to be false, if the predicted probability for a wrong class is high. However, if the cumulative confidence level which aggregates the contributions of multiple data samples is high, it is highly possible that the cumulative DNN inference result is accurate. The accuracy is estimated as the average ratio of correct inference among all AI classification tasks with different data traces. FIG. 12 shows the relationship between accuracy and the number of data samples for both fast and full DNN inference. The accuracy at j=1 denotes the accuracy with no cumulative DNN inference. Specifically, at j=1, the full DNN model achieves an accuracy of around 80%, and the fast DNN model achieves an accuracy of around 64%. With the cumulative DNN inference scheme, the predicted true class probability is improved by aggregating more data samples, leading to an accuracy increase as illustrated in FIG. 12. With more data samples, the accuracy gradually increases to 1, with a larger increasing speed for full DNN inference. It is understood that it may be unnecessary to have the predicted true class probability be very close to 1 for correct inference. For example, with pure fast DNN inference, the cumulative confidence level at j=20 with a mean at around 0.95 and a standard deviation less than 0.1, as illustrated in FIG. 11B. In this case, the predicted true class probabilities for most data traces are high enough for correct inference to have an accuracy close to 1. It may be considered that both performance metrics, namely confidence level and accuracy, are positively correlated. To increase the inference accuracy, optimization of the confidence level of each AI task can be performed instead, as accuracy is a statistical measure and not defined for a specific task, while confidence level is defined for a single task.

According to embodiments, the performance of the adaptive control scheme is further discussed. The performance of the deep Q learning algorithm for adaptive offloading decision is further discussed. For time slot k in an episode, the current cumulative confidence levels, represented as η(k), are part of state sₖ. To determine the state transitions in terms of the cumulative confidence levels, we use the cumulative confidence level traces obtained from the cumulative DNN inference scheme. For simplicity, the average cumulative confidence level traces are used for both fast and full DNN inference. Consider differentiated task completion time requirements for the three devices, which are set as [9, 11, 13] in number of time slots. Assuming the devices have the same confidence level requirement, η_{T}, for their AI classification tasks, evaluation of the performance of the deep Q learning algorithm for three different values of η_{T} among {0.93, 0.95, 0.97}, where ω₁=0.90 by default, can be determined.

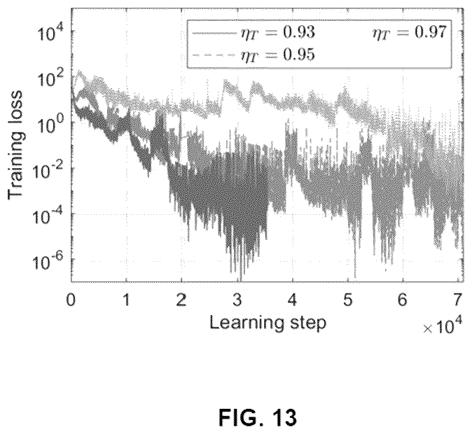

FIG. 13 shows the convergence of the deep Q learning algorithm in terms of training loss versus number of learning steps, for different confidence level requirements. With a larger value of η_{T}, it is more difficult for the learning algorithm to converge, and it takes a longer time to reduce the training loss to below 10⁻². For example, the training loss for η_{T}=0.93 is quickly reduced to below 10⁻⁵ with around 30000 learning steps, while the training loss for η_{T}=0.97 is slowly reduced to below 10⁻² in a more than doubled training time. The convergence speed for η_{T}=0.95 is in the middle.

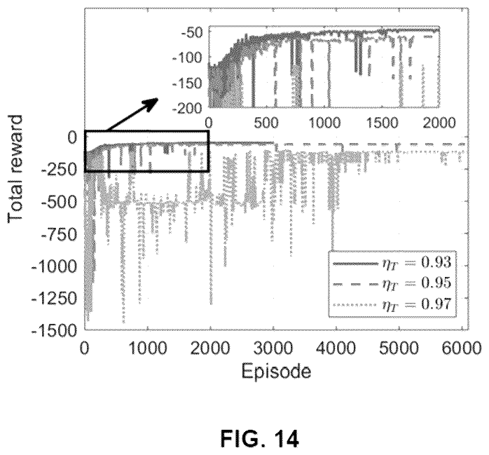

FIG. 14 shows the episodic total reward during the training process, for different confidence level requirements. It can be observed that the total reward for η_{T}=0.93 increases most quickly and converges at around 1700 episodes without QoS violation penalty. In comparison, the total reward for η_{T}=0.95 increases in a slightly slower speed and converges with more than 2000 episodes. The total reward for η_{T}=0.97 shows the worst convergence, with huge delay violation penalty before 2000 episodes and significant fluctuations between episode 2000 and episode 5000. It finally converges after around 5000 episodes. The convergence in episodic total reward is consistent with the convergence in training loss. Weight ω₁=0.90 places more emphasis on minimizing the network resource consumption rather than local energy consumption. In this case, it is preferable to execute additional fast DNN inferences locally to minimize the total cost. As each fast DNN inference tends to provide less confidence level gain and at most one fast inference result can be generated at each device in one time slot, it requires more time slots to satisfy the confidence level requirement. Therefore, it can be easier to have delay violation if η_{T} is large. With larger η_{T}, it can be more difficult for the RL agent to learn the no delay violation penalty behavior corresponding to confidence level satisfaction before deadline. As such, the convergence performance in terms of both training loss and episodic total reward can be the worst for η_{T}=0.97. After convergence, the delay violation penalty is suppressed, and the confidence level can be satisfied at or very close to deadline. It can be observed that the total reward after convergence is larger for a lower confidence level requirement.

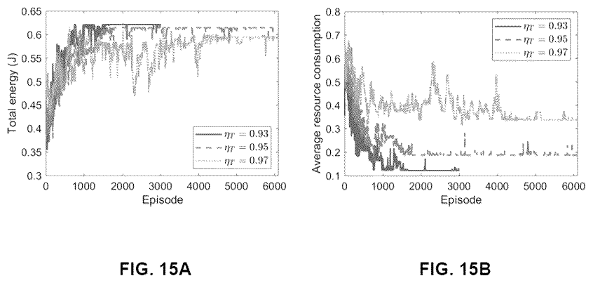

Due to the priority on minimizing the network resource consumption at ω₁=0.90, it can be seen in FIG. 15A that the average resource consumption gradually decreases with more learning episodes. As can be seen in FIG. 15B it can be seen that the total local energy shows an increasing trend. These figures thus demonstrate a trade-off between the two metrics. For example, the average resource consumption is lower for a smaller value of η_{T}, as less offloading is triggered to satisfy the QoS requirement. However, the total energy is higher for a smaller η_{T}, due to larger local computing energy for one fast DNN inference than transmission energy for offloading one intermediate data sample under the simulation setting.

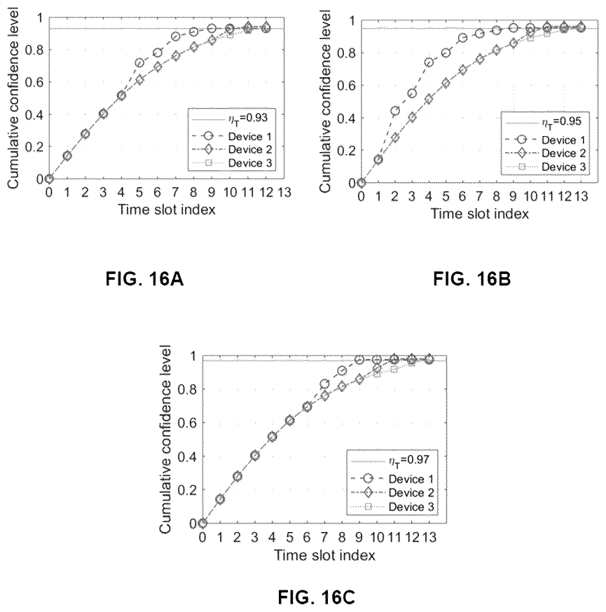

FIGS. 16A, 16B and 16C show the increase of cumulative confidence levels over time for the three devices with the trained RL agents at different values of η_{T} for ω₁=0.90. It can be observed that the confidence level requirements for all the devices are satisfied just at (or very close to) the required deadlines, which are [9, 11, 13] in number of time slots, at different values of η_{T}. As local processing incurs less cost than offloading for ω₁=0.90 but has lower confidence level gain, the RL agent learns an intelligent offloading decision sequence with minimal offloading that can satisfy the confidence level requirements without delay violation with the minimum cost. Moreover, the trained RL agent may also learn how to prioritize the offloading opportunities among the three devices with different delay requirements. For device 1 with the most stringent delay requirement, it can be observed that the cumulative confidence level can increase faster than the other two devices due to more offloading earlier.

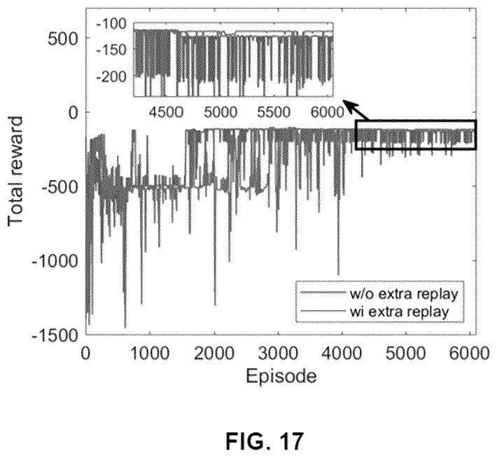

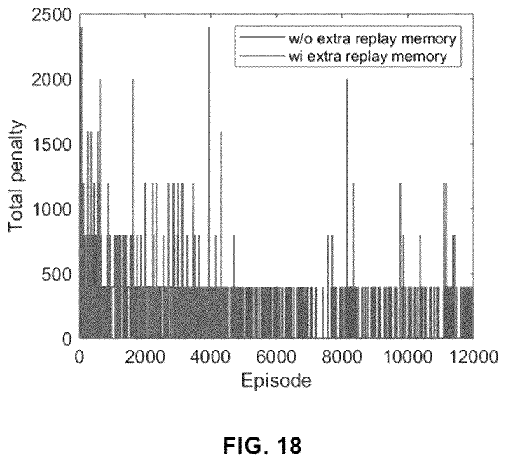

According to embodiments, in order to evaluate the benefit of an extra experience replay which stores the transitions in episodes with no penalty, a comparison of both the episodic (smoothed) total reward and the episodic total penalty during the training process with and without the extra experience replay, with results shown in FIG. 17 and FIG. 18, respectively. For a suitable comparison, a mini batch of 2N experiences are sampled from the ordinary experience replay memory at each learning step without the extra experience replay memory. For both without and with the extra experience replay memory, the evaluation DQN is trained twice at each learning step, with N sampled experiences for each of the trainings. As illustrated in FIG. 17 and FIG. 18, the total reward with the extra experience replay memory converges after around 5000 episodes with no penalty at most time points, while the penalty without the extra experience replay memory is still high after convergence. It can also be observed that the total reward without the extra experience replay memory increases faster due to more training with diverse training experiences in the early training stage. However, with the extra experience replay memory, the sampled experiences from the extra experience replay memory lacks diversity in the early training stage, as the episodes with no penalty are rare and the number of samples in the extra experience replay memory increases slowly. As a result, the training with sampled experiences from the extra experience replay memory does not explore the state action space well in the early training stage. After the extra experience replay memory stores sufficient good samples, the total reward finally converges to a larger value with negligible delay violation penalty as compared to the instance without the extra experience replay memory. For the instances without the extra experience replay memory, the earlier convergence to a worse solution can occur because it cannot put priority on remembering and learning from the special good samples in the no-penalty episodes. In this case, all the samples have equal priority, and are gradually replaced by new samples once the extra experience replay memory is full.

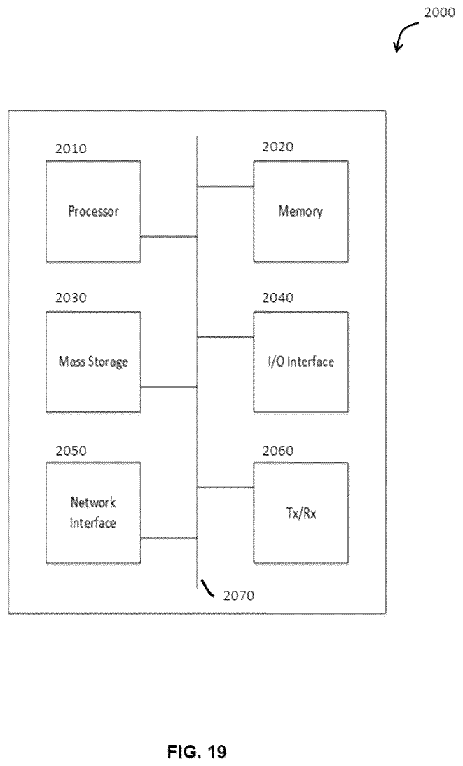

FIG. 19 is a schematic diagram of an electronic device 2000 that may perform any or all of operations of the above methods and features explicitly or implicitly described herein, according to different embodiments of the present disclosure. For example, a computer equipped with network functions may be configured as electronic device 2000. In some embodiments, the electronic device 2000 may be a user equipment (UE), an AP, a STA, network entity or the like as would be readily appreciated by a person skilled in the art.

As shown, the electronic device 2000 may include a processor 2010, such as a central processing unit (CPU) or specialized processors such as a graphics processing unit (GPU) or other such processor unit, memory 2020, non-transitory mass storage 2030, input-output interface 2040, network interface 2050, and a transceiver 2060, all of which are communicatively coupled via bi-directional bus 2070. According to certain embodiments, any or all the depicted elements may be utilized, or only a subset of the elements. Further, electronic device 2000 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 2020 may include any type of non-transitory memory such as static random-access memory (SRAM), dynamic random-access memory (DRAM), synchronous DRAM (SDRAM), read-only memory (ROM), any combination of such, or the like. The mass storage element 2030 may include any type of non-transitory storage device, such as a solid-state drive, hard disk drive, a magnetic disk drive, an optical disk drive, USB drive, or any computer program product configured to store data and machine executable program code. According to certain embodiments, the memory 2020 or mass storage 2030 may have recorded thereon statements and instructions executable by the processor 2010 for performing any of the method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, personal digital assistant (PDA), or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes instructions that enable a computer device (personal computer, server, or network device) to execute the methods provided in the embodiments of the present disclosure. For example, such an execution may correspond to a simulation of the logical operations as described herein. The software product may additionally or alternatively include instructions that enable a computer device to execute operations for configuring or programming a digital logic apparatus in accordance with embodiments of the present disclosure.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any modifications, variations, combinations, or equivalents that fall within the scope of the present invention.

1. A method for cumulative deep neural network (DNN) inference, the method comprising:
receiving, by a Type-D network element, fast DNN inference results for a first artificial intelligence (AI) task;
receiving, by the Type-D network element, full DNN inference results for the first AI task;
obtaining, by the Type-D network element, a cumulative DNN inference result based on the fast DNN inference results and the full DNN inference results; and
obtaining, by the Type-D network element, a cumulative confidence level based on the fast DNN inference results and the full DNN inference results.

2. The method of claim 1, wherein receiving the full DNN inference results is responsive to an enhanced inference request.

3. The method of claim 2, wherein the enhanced inference request is at least in part based on one or more of: dynamics of the cumulative confidence level, a caching status and a remaining time to a deadline associated with the first AI task.

4. The method of claim 1, wherein the full DNN inference results are based on intermediate data, the intermediate data indicative of partial determination of the fast DNN inference results.

5. An apparatus for cumulative deep neural network (DNN) inference, the apparatus comprising:
a processor;
a network interface; and
a memory having stored thereon machine executable instructions, the instructions when executed by the processor configure the apparatus to:
receive fast DNN inference results for a first artificial intelligence (AI) task;
receive full DNN inference results for the first AT task;
obtain a cumulative DNN inference result based on the fast DNN inference results and the full DNN inference results; and
obtain a cumulative confidence level based on the fast DNN inference results and the full DNN inference results.

6. The apparatus of claim 5, wherein receiving the full DNN inference results is responsive to an enhanced inference request.

7. The apparatus of claim 6, wherein the enhanced inference request is at least in part based on one or more of: dynamics of the cumulative confidence level, a caching status and a remaining time to a deadline associated with the first AI task.

8. The apparatus of claim 5, wherein the full DNN inference results are based on intermediate data, the intermediate data indicative of partial determination of the fast DNN inference results.

9. A method for cumulative deep neural network (DNN) inference, the method comprising:
transmitting, by a controller, one or more of a data request and an enhanced inference request, wherein the data request is for a first artificial intelligence (AI) task and wherein the enhanced inference request is for a full DNN inference result for the first AI task;
receiving, by the controller, a cumulative confidence level for a current DNN inference result; and
receiving, by the controller, task requirements for the first AI task.

10. The method of claim 9 further comprising determining, by the controller, acceptability of the cumulative DNN inference for the first AI task based at least in part on the task requirements and the cumulative confidence level.

11. The method of claim 9, wherein the data request includes a request for one or more new data samples from a data source.

12. The method of claim 11, wherein the data request includes a request of one or more new fast DNN inference results.

13. The method of claim 9, wherein the enhanced inference request includes a request for one or more samples of intermediate data for determination of the full DNN inference result for the first AI task.

14. The method of claim 13, further comprising;
receiving, by the controller, the full DNN inference result; and
upon determination that the full DNN inference result is sufficient, transmitting, by the controller a notification to both a Type-B network element and a Type-D network element.

15. The method of claim 14, wherein upon receipt of the notification, the Type-B network element ceases determining a new fast DNN inference.

16. The method of claim 14, wherein upon receipt of the notification, the Type-D network element ceases determining a cumulative DNN inference result.

17. The method of claim 9, wherein the task requirements include information indicative of one or more of a deadline and a confidence level.

18. The method of claim 17, wherein the deadline includes a delay threshold and the confidence level includes a confidence level threshold.

19. The method of claim 18, wherein the first AI task is completed upon the cumulative confidence level reaching the confidence level threshold.

20. The method of claim 19, wherein the first AI task is completed with a satisfactory quality of service (QoS) upon the first AI task being completed by at least the delay threshold.
